(19) United States
(12) Patent Application Publication
(10) Pub. No.: US 2025/0286379 A1
(43) Pub. Date: Sep. 11, 2025

(54) LOAD FREQUENCY STABILIZATION USING OPTIMIZED MPC-(1+PIDN) CONTROLLER FOR HIGH ORDER INTERCONNECTED RENEWABLE ENERGY BASED POWER SYSTEMS

(71) Applicant: KING FAHD UNIVERSITY OF PETROLEUM AND MINERALS, Dhahran (SA)

(72) Inventor: Muhammad Majid GULZAR, Dhahran (SA)

(73) Assignee: KING FAHD UNIVERSITY OF PETROLEUM AND MINERALS, Dhahran (SA)

(21) Appl. No.: 18/738,582

(22) Filed: Jun. 10, 2024

Related U.S. Application Data
(60) Provisional application No. 63/562,529, filed on Mar. 7, 2024.

(51) Int. Cl. H02J 3/24; H02J 3/38

(52) U.S. Cl. CPC H02J 3/241; H02J 3/381; H02J 2203/10; H02J 2203/20; H02J 2300/24; H02J 2300/28; H02J 2300/40

(57) ABSTRACT

A load frequency control system for a multi-area hybrid power grid having multiple regions which integrates renewable energy sources. The system includes individual power systems in separate geographic regions, interconnected by electrical tie-lines. Area control signals (ACE) generated by each power system facilitate adaptive frequency stabilization. A central model predictive controller (MPC) processes ACE signals to produce control signals, guiding a one plus proportional integral derivative (1+PIDN) controller with adjustable gain parameters. An optimizer applies a salp swarm algorithm to the ACE signals to dynamically adjust gain parameter of the 1+PIDN controller. The resulting output signal from the 1+PIDN controller is designed to mitigate power disturbances and maintain frequency balance across the tie-lines, ensuring robust and responsive grid management.

### STATEMENT REGARDING PRIOR DISCLOSURE BY THE INVENTORS

Aspects of this technology are described in an article “Designing Of Robust Frequency Stabilization Using Optimized MPC-(1+PIDN) Controller For High Order Interconnected Renewable Energy Based Power Systems” published in Protection and Control of Modern Power Systems 8, in January 2023, which is incorporated herein by reference in its entirety.

### CROSS REFERENCE TO RELATED APPLICATIONS

The present application claims the benefit of priority to U.S. Prov. App. No. 63/562,529, entitled “Designing Of Robust Frequency Stabilization Using Optimized MPC-(1+PIDN) Controller For High Order Interconnected Renewable Energy Based Power Systems”, filed on Mar. 7, 2024, and incorporated herein by reference in its entirety.

### STATEMENT OF ACKNOWLEDGEMENT

Support provided by the King Fahd University of Petroleum and Minerals (KFUPM), Riyadh, Saudi Arabia through Project No. EC221008 is gratefully acknowledged.

### BACKGROUND

### Technical Field

The present disclosure is directed to a controller for high-order interconnected renewable energy based power system.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Adoption of renewable energy sources is on the rise owing to their potential to offer a practically limitless supply of clean energy, aligning with global efforts to combat climate change and reduce carbon emissions. However, the variable power output of these resources presents significant challenges. Solar energy production fluctuates due to diurnal cycles and weather conditions, while wind energy generation fluctuates due to varying wind speeds and directions. This intermittency creates a mismatch between renewable energy generation and peak consumer demand periods, complicating the integration of renewable energy sources into existing power grid infrastructures.

Frequency stabilization in renewable energy system (RES) networks is essential for maintaining grid integrity and ensuring a reliable power supply. Electrical frequency, measured by the number of alternating current cycles per second in the grid, must adhere to strict limits based on regional standards. The need for frequency stabilization arises from inherent characteristics of RES. Unlike traditional power plants with predictable outputs, renewable energy systems such as solar and wind, are inherently intermittent, leading to rapid and unpredictable fluctuations in power generation. These fluctuations can cause imbalances between power supply and demand, resulting in frequency variations. Such deviations from the nominal frequency can disrupt power generation, transmission, and distribution efficiency, potentially causing damage to infrastructure and end-user equipment.

In RES-dependent power grids, the challenge of frequency stabilization is heightened due to the stochastic nature of renewable energy production. For instance, solar panels produce less energy during cloudy periods, and wind turbine output is contingent on wind conditions. This dependence can cause sudden drops or spikes in power generation, which may destabilize the power system if not managed effectively,

To address destabilization challenges, frequency stabilization strategies often combine fast-acting energy storage systems with advanced control mechanisms such as load frequency control (LFC) and automatic generation control (AGC). These controllers regulate generator outputs and coordinate network resources to maintain frequency within the required range. Frequency fluctuations stem from load-generation imbalances and nonlinear factors such as generation rate constraints (GRC). LFC and AGC manage both frequency and power interchange across tie-lines in interconnected regions to balance loads and power generation.

Extensive research has focused on controller performance in complex energy networks. Literature highlights various controllers for LFC, with PI/PID controllers commonly deployed for frequency stabilization. PI/PID controllers play a crucial role in maintaining nominal frequency in power systems, impacting operational stability significantly. Optimizing PI/PID controllers aims to enhance their performance in complex power network environments. However, the response time of these optimized controllers may still be suboptimal in intricate networks characterized by diverse energy inputs and demand fluctuations.

Various metaheuristic techniques have been employed to derive optimal parameters for these controllers, using algorithms, such as the bacterial foraging optimization algorithm (BFOA), the firefly algorithm (FA), and genetic algorithms (GA) in the AGC controller design. Furthermore, alternative control structures have been investigated to enhance effectiveness. In an example, integral double derivative (IDD) controllers, when operated by a lightning search algorithm (LSA), have been applied for LFC, though additional oscillations are introduced in the frequency response. Controllers based on integral order (IO), intelligence, and degrees of freedom, including 2DOF and the advanced 2DOF, have also been introduced to augment AGC performance.

In scenarios of multi-area power systems, which are inherently more complex due to the interaction between multiple energy-producing regions, cascaded controllers have been implemented. The cascaded controllers have been proven effective in demonstrating their capability to maintain system stability. However, cascaded controllers can be complex to design and tune. The process of adjusting multiple control parameters to achieve desired system behavior is intricate and often requires sophisticated computational techniques. Optimization algorithms, such as the grey wolf optimizer (GWO) and the bat algorithm (BA), have been applied to tune the PI-PD controllers, exhibiting their ability to fine-tune control parameters in pursuit of optimal system behavior, including the mitigation of frequency oscillations in electric vehicles. The opitimization algorithms search through a wide solution space to find optimal settings. Such algorithms can be computationally challenging, particularly for real-time applications.

High-complexity algorithms, such as the Harris Hawks optimization have shown advancements, but present a high level of complexity that can be a barrier to practical implementation.

Additionally, hybrid algorithms combining stochastic fractal search and pattern search techniques (hSFS-PS) have also been implemented to advance the control capability of PI-PD controllers. Nevertheless, many of these techniques were tested within simplified systems, predominantly limited to two-area networks.

To address the deficiencies of existing controllers, fuzzy/adaptive based PI/PID controller tuning has been used. However, the integration of fuzzy controllers introduces complexity. Internal model controllers (IMC) based on PI design have been developed to address LFC challenges, and advanced methods, such as dropout deep neural networks with transfer learning have been utilized for optimal AGC dispatch. Moreover, dispatch techniques using a model predictive controller (MPC) framework have been disclosed for maximizing total profit by dynamic variation in the AGC. The MPC is especially valued for its rapid response and robustness against load disruption and uncertainty. The application of MPCs has been explored in thermal systems and for systems connected to photovoltaic (PV) installations, yet the performance in complex networks has not been fully analyzed. Recent studies have introduced MPC-PI gain scheduling and adaptive AGC dispatch methods for renewable energy integration to enhance frequency regulation in more complex multi-area systems. Active disturbance rejection control (LADRC) has also been designed for such systems to address LFC issues effectively.

Thus, it is identified that conventional control techniques, such as proportional-integral-derivative (PI/PID) controllers, face challenges in diminishing uncertainty due to system errors. Cascaded formation designs have been introduced to improve controller performance, yet do not robustly address this uncertainty. The complexity of power system networks, particularly in higher-order areas, results in significant gaps in the analysis and efficacy of controller designs for such systems.

US20130268131A1 describes a multi-area power control system that is designed to manage power distribution across interconnected regions. The system monitors various parameters such as frequency, tie-line power, and total active power loss, which are essential for maintaining grid stability. However, this reference does not incorporate a self-adaptive learning particle (SALP) algorithm, nor does it include the MPC or the 1+PID controller design.

CN112636368B describes an automatic power generation control method for a multi-source, multi-area interconnected power system. The method describes a fractional order PID controller that is optimized using the celestial beard algorithm. Although this reference provides a sophisticated approach to power generation control, this reference lacks the integration of a cascaded MPC with a 1−PIDN controller and does not utilize SALP optimization.

US20050127680A1 describes a central controller system tasked with monitoring power generation across multiple areas. It emphasizes the importance of centralized monitoring and management for stable power distribution. However, this system does not discuss the innovative approach of a cascaded MPC with a 1−PIDN controller, nor does it mention the implementation of a SALP optimization technique.

Each of the aforementioned patents presents advancements in power system control but also possesses limitations in their scope and capability, failing to address the specific innovations of the present invention. The identified patents do not suggest a comprehensive solution that combines the cascaded MPC with a 1−PIDN controller design, along with SALP optimization, to effectively manage the dynamic and complex nature of multi-area interconnected power systems.

Thus, there exists a need for an integrated approach to enhance the control and stability of power systems that integrate multiple energy sources and regions. The present invention aims to fulfill this need by providing a novel control system that not only encompasses the necessary advancements over the prior art but also introduces a methodical and simplified design process that obviates the complexities associated with current power control technologies. Consequently, it is an object of the present disclosure to offer a method and system for the integration of multi-area power systems with renewable energy sources, which employs a model predictive controller cascaded with a 1−PIDN controller for improved performance and efficiency.

### SUMMARY

In an exemplary embodiment, a load frequency control system for a multi-region power system incorporating a plurality of renewable energy sources is described. The load frequency control system includes a first power system located in a first geographic region, a second power system located in a second geographic region, a third power system located in a third geographic region, a fourth power system located in a fourth geographic region, a first electrical tie-line configured to connect the first power system with the second power system, a second electrical tie-line configured to connect the first power system with the third power system, a third electrical tie-line configured to connect the second power system with the third power system, and a fourth electrical tie-line configured to connect the first power system with the fourth power system. Each power system is configured to generate area control signals (ACE). The load frequency control system further includes a model predictive controller (MPC) operatively connected to receive the ACE signals from each electrical tie-line. The MPC includes a memory storing program instructions, and at least one processor configured to execute the program instructions to generate a control signal u(k). The load frequency control system further includes a one plus proportional integral derivative (1+PIDN) controller operatively connected to the MPC. The 1+PIDN controller includes a set of amplifiers having gain parameters. The load frequency control system further includes an optimizer operatively connected to the MPC. The optimizer is configured to receive the ACE signals, apply the ACE signals to a salp swarm algorithm and update the gain parameters of the 1+PIDN controller. The 1+PIDN controller is configured to receive the control signal u(k) and the updated gain parameters and generate an output signal to mitigate power disturbances due to frequency imbalances on the first electrical tie line, the second electrical tie-line, the third electrical tie-line, and the fourth electrical tie-line.

In another exemplary embodiment, a method for load frequency control of a multi-region power system incorporating a plurality of renewable energy sources is described. The method includes connecting a first power system located in a first geographic region to a second power system located in a second geographic region by a first electrical tie-line, connecting the first power system to a third power system located in a third geographic region by a second electrical tie-line, connecting the second power system to the third power system by a third electrical tie-line, and connecting the first power system to a fourth power system located in a fourth geographic region by a fourth electrical tie-line. The method further includes generating, by each power system, area control signals (ACE) and receiving, by a model predictive controller (MPC), the ACE signals from each power system. The MPC includes a memory storing program instructions and at least one processor configured to execute the program instructions. The method further includes generating, by the MPC, a control signal u(k), connecting a one plus proportional integral derivative (1+PIDN) controller, which includes a set of amplifiers having gain parameters to the MPC, and connecting an optimizer to the MPC. The method further includes receiving, by the optimizer, the ACE signals, applying, by the optimizer, the ACE signals to a salp swarm algorithm, and updating, by the optimizer, the gain parameters. The method further includes receiving, by the 1+PIDN controller, the control signal u(k) and the updated gain parameters and generating, by the 1+PIDN controller, an output signal to mitigate power disturbances due to frequency imbalances on the first electrical tie line, the second electrical tie-line, the third electrical tie-line, and the fourth electrical tie-line.

In another exemplary embodiment, a hybrid load frequency controller for interconnected multi-region power systems incorporating a plurality of renewable energy sources is described. The hybrid load frequency controller includes a model predictive controller (MPC) operatively connected to receive area control error (ACE) signals from electrical tie-lines which interconnect the multi-region power systems. The MPC includes a memory and at least one processor configured to execute the program instructions to generate a control signal u(k). The hybrid load frequency controller further includes one plus proportional integral derivative (1+PIDN) controller operatively connected to the MPC. The 1+PIDN controller includes a set of amplifiers having gain parameters. The hybrid load frequency controller further includes an optimizer operatively connected to the MPC. The optimizer is configured to receive the ACE signals, apply the ACE signals to a salp swarm algorithm and update the gain parameters of the 1+PIDN controller. The 1+PIDN controller is configured to receive the control signal u(k) and the updated gain parameters and generate an output signal configured to mitigate power disturbances due to frequency imbalances on the electrical tie-lines which interconnect the multi-region power systems.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 illustrates a block diagram of a load frequency control (LFC) system implemented within a multi-area hybrid power model, according to certain embodiments.

FIG. 2 illustrates a pole-zero map of a control system for a fourth power system corresponding to a fourth geographic area, according to certain embodiments.

FIG. 3 illustrates a block diagram of a photovoltaic (PV) system interconnected to the LFC system for a multi-region power system, according to certain embodiments.

FIG. 4 illustrates a block diagram of a wind energy unit, according to certain embodiments.

FIG. 5A illustrates a schematic diagram of a controller integrating a model predictive controller (MPC) with a 1+proportional integral derivative plus number (1+PIDN) controller, according to certain embodiments.

FIG. 5B illustrates a configuration of a load frequency control system designed for four interconnected power systems, according to certain embodiments.

FIG. 6 illustrates a flowchart for implementing a salp swarm algorithm (SSA) used in an MPC combined with a 1+PIDN controller in a Simulink model, according to certain embodiments.

FIG. 7 illustrates a graphical representation of abrupt load deviations over time, according to certain embodiments.

FIG. 8A illustrates the frequency response of the controller implemented in a first geographic area, according to certain embodiments.

FIG. 8B illustrates an exploded view of a section of the frequency response of the controller of FIG. 8A, according to certain embodiments.

FIG. 9A illustrates the frequency response of the controller implemented in a second geographic area, according to certain embodiments.

FIG. 9B illustrates an exploded view of a section of the frequency response of the controller of FIG. 9A, according to certain embodiments.

FIG. 10A illustrates the frequency response of the controller implemented the a third geographic area, according to certain embodiments.

FIG. 10B illustrates an exploded view of a section of the frequency response of the controller of FIG. 10A, according to certain embodiments.

FIG. 11A illustrates the frequency response of the controller implemented in a fourth geographic area, according to certain embodiments.

FIG. 11B illustrates an exploded view of a section of the frequency response of the controller of FIG. 11A, according to certain embodiments.

FIG. 12 depicts a frequency deviation graph comparing the performance of various controllers within a power system, according to certain embodiments.

FIG. 13 illustrates a tie-line power-sharing response in a first power system of a first geographic area for various controllers, according to certain embodiments.

FIG. 14 presents a tie-line power-sharing response of various controllers implemented within a second power system, according to certain embodiments.

FIG. 15 illustrates a tie-line power-sharing response of the various controllers implemented within a third power system, according to certain embodiments.

FIG. 16 illustrates a tie-line power-sharing response of the various controllers implemented within a fourth power system, according to certain embodiments.

FIG. 17 illustrates a load deviation response of a controller over time for a system subjected to random load variations, according to certain embodiments.

FIG. 18 illustrates a comparison of the MPC-(1+PIDN) controller with various controllers of the frequency response in the first power system implemented in the first geographic area, according to certain embodiments.

FIG. 19 illustrates a comparison of the MPC-(1+PIDN) controller with various controllers of the frequency response of the second power system implemented in the second geographic area, according to certain embodiments.

FIG. 20 illustrates a comparison of the MPC-(1+PIDN) controller with various controllers of the frequency response of the third power system implemented in the third geographic area, according to certain embodiments.

FIG. 21 illustrates a comparison of the MPC-(1+PIDN) controller with various controllers of the frequency response of the fourth power system implemented in the fourth geographic area, according to certain embodiments.

FIG. 22 illustrates a comparison of the MPC-(1+PIDN) controller with various controllers of a tie-line response between the first geographic area and the second geographic area, according to certain embodiments.

FIG. 23 illustrates a comparison of the MPC-(1+PIDN) controller with various controllers of a tie-line response between the first geographic area and the third geographic area, according to certain embodiments.

FIG. 24 illustrates a comparison of the MPC-(1+PIDN) controller with various controllers of a tie-line response between the second geographic area and the third geographic area, according to certain embodiments.

FIG. 25 a comparison of the MPC-(1+PIDN) controller with various controllers of illustrates a tie-line response between the first geographic area and the fourth geographic area, according to certain embodiments.

FIG. 26A illustrates the PV power output versus time, according to certain embodiments.

FIG. 26B illustrates the deviation in wind power output versus time, according to certain embodiments.

FIG. 26C illustrates the deviation in hydroelectric plant power output versus time, according to certain embodiments.

FIG. 26D illustrates the deviation in the combined hydroelectric plant plus PV plus wind power output versus time, according to certain embodiments.

FIG. 27 illustrates details of computing hardware of the cascaded MPC 1+PIDN controller, according to certain embodiments.

FIG. 28 is an exemplary schematic diagram of a data processing system used within the computing system, according to certain embodiments.

FIG. 29 is an exemplary schematic diagram of a processor used with the computing system, according to certain embodiments.

FIG. 30 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

A geographic area, alternately referred to as a geographic region, is defined as an portion of the surface of the earth which is bounded by latitudinal and longitudinal coordinates. Each geographic area may have a plurality of electrical power generators which provide power to a load center located in the geographic area. The power generators of each geographic area are operatively connected to a common utility grid. Tie-lines, as described below, interconnect the power systems of the different geographic areas. In the present disclosure, the geographic area may be alternately be referred to as a geographic region, a geographic power area or a geographic power region.

In the present disclosure, the plurality of electrical power generators may include thermal power generators as well as renewable energy generators, which include photovoltaic (PV) arrays, wind turbines and hydroelectric power generators.

Thermal power generation consists of using steam power created by burning oil, liquid natural gas (LNG), coal, and other substances to rotate generators and create electricity. Thermal power generation plays a central role in supplying power because it can flexibly respond to the various ways in which power is used (demand fluctuations) as the power output grows larger. Aspects of this disclosure are directed to a load frequency control (LFC) system and a method for load frequency control of a power network. The LFC system includes four interconnected power systems located in different geographic areas, each with an assortment of power generation sources, including photovoltaic (PV), wind, thermal, and hydroelectric power generators. The stability of the LFC system is dependent on the effectiveness of the LFC controller, especially with the varying input from renewable sources and the challenges posed by the inclusion of a hydroelectric power system, which introduces specific dynamics into the power system which require a robust control solution.

To address these challenges, the LFC controller is embodied as a model predictive controller (MPC) cascaded with a one plus proportional integral derivative with filter (1+PIDN) controller. A salp swarm algorithm (SSA) is implemented for the optimization of the parameters of the 1+PIDN controller. The MPC-(1+PIDN) controller is specifically configured to stabilize frequency within high-order interconnected areas. The MPC-(1+PIDN) controller results in rapid frequency stabilization across all four areas, faster than traditional control methods.

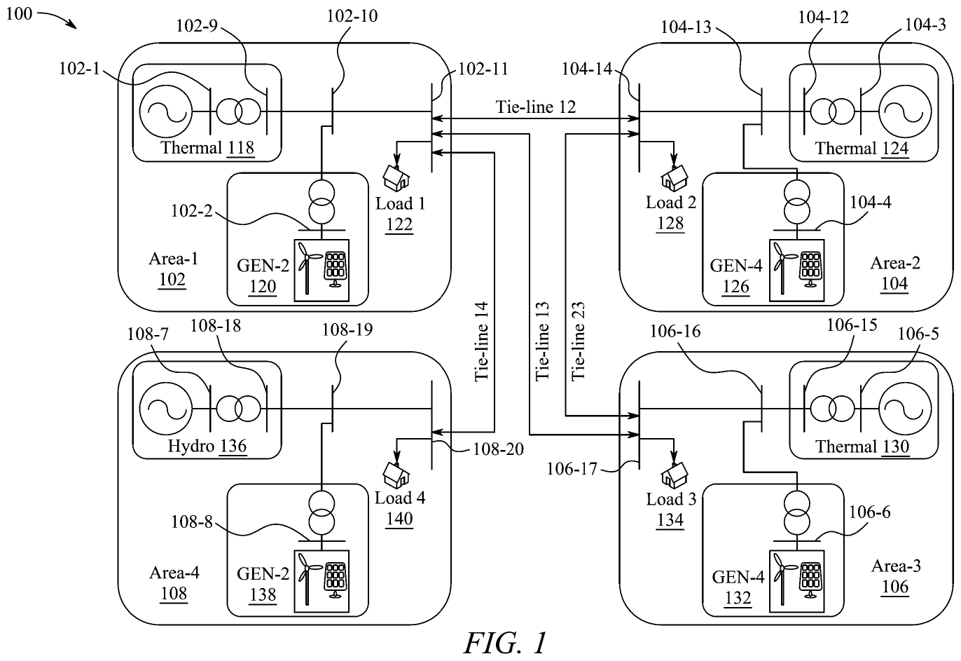

FIG. 1 illustrates a block diagram of a load frequency control (LFC) system 100 implemented within a multi-area hybrid power network. The LFC system 100 is integrated within a grid-connected, multi-area power infrastructure designed to optimally distribute and stabilize power frequency across various distinct geographic areas. The hybrid model is one illustration of power management systems designed to integrate various combinations of energy resources, including renewable energy resources and traditional energy resources, to manage the effective distribution and stabilization of power frequency across various geographic zones.

The LFC system 100 can be implemented in a plurality of geographic areas. The geographic area may be a city, a district, a county, a combination of towns, and the like. In one illustration, FIG. 1 demonstrates the LFC system 100 as applied to a four-area power network, incorporating multiple energy resources integrated to serve the energy requirements of each geographic area. The LFC system 100 includes a first power system 102 located in a first geographic area (area-1), a second power system 104 located in a second geographic area (area-2), a third power system 106 situated in a third geographic area (area-3), and a fourth power system 108 positioned in a fourth geographic area (area-4). The first, second, and third power systems 102, 104, and 106 are integrated with a combination of renewable energy resources, such as wind, solar, and thermal energy resources, and the fourth power system 108 is integrated with wind, solar, and hydroelectric power energy resources.

Each power system 102, 104, 106 and 108 includes respective energy-generating units and associated loads. Specifically, the first power system 102 includes at least three energy resources, including a first thermal generator 118 and a first renewable energy unit 120 which integrates a photovoltaic energy generator and a wind energy generator. The first thermal generator 118 is connected to a traditional energy generator side busbar 102-1. The first photovoltaic energy generator and a first wind energy generator are connected to a renewable energy generator side busbar 102-2.

The generator side busbar is the point where the electrical power generated by the various generating units, such as thermal, wind, and hydro, within a power system area, is collected. The generator side busbar is a common electrical junction to which the outputs of all generators are connected. The voltage level at the generator side busbar is typically high because it serves as a collection point for the generated power before it is transmitted or stepped up for transmission over long distances.

From the traditional energy generator side busbar 102-1, the power generated by the thermal unit 118 is collected by a load busbar 102-9. Similarly, from the renewable energy generator side busbar 102-2, the power generated by the first renewable energy unit 120 is collected by a load busbar 102-10.

The load busbar is the point of distribution where the power is delivered from the power system to the different loads. The power at the load busbar has usually been stepped down to a lower voltage suitable for local distribution. It distributes power to various consumers, including any of residential, commercial and industrial users. In FIG. 1, the power collected by the load busbar 102-9 and the load busbar 102-10 is delivered to an area-1 102 busbar 102-11. The busbar 102-11 is connected to a load 122. The busbar 102-11 is also referred to as the first busbar. The load 122 represents the energy consumers in the power system 102 of area-1. The busbar 102-11 (first busbar) is connected to one or more of the electrical tie-lines (for example, tie-line 12, tie-line 13, tie-line 14 and tie-line 23). The power disturbances in the tie-lines are due to changes in a demand of the load and fluctuation in the energy generating resources located in the power system of area-1 102.

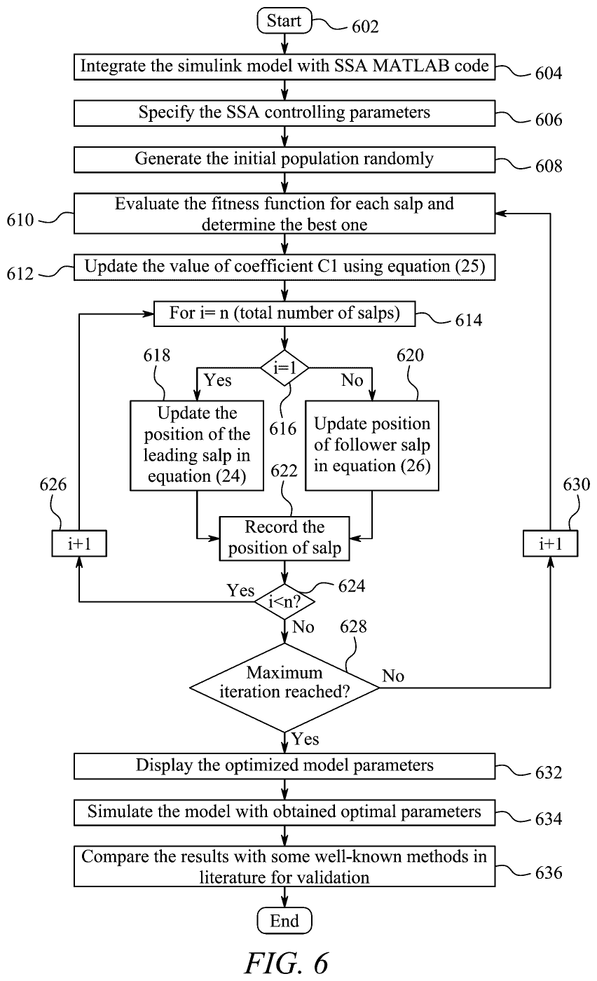

The busbar 102-11 is further connected to receive the power disturbances from each of the first electrical tie-line 12, the second electrical tie-line 13, and the fourth electrical tie-line 14. As shown in FIG. 5B, the first power system 102 also includes a frequency meter 512 configured to measure a frequency on each of the first electrical tie-line 12, the second electrical tie-line 13 and the fourth electrical tie-line 14 and generate a combined frequency measurement. The first power system 102 further includes a first subtractor 514 configured to subtract the combined frequency measurement from a reference frequency 516 and generate a power to frequency ratio bias signal 524. The first power system 102 further includes an interchange scheduler 518 configured to generate a time window for an exchange of power from the first busbar to the MPC-(1+PIDN) controller 508. Further, the first power system 102 includes a second subtractor 520 configured to receive the power disturbances from the first busbar and transmit the power disturbances during the time window. The first power system 102 further includes a third subtractor 522 configured to subtract the power to frequency ratio bias signal from the scheduled power disturbances and generate an ACE₁ signal.

Referring back to FIG. 1, the second power system 104 of area-2 incorporates at least three energy resources, including a second thermal generator 124, a second renewable energy unit 126 that integrates a photovoltaic energy generator and a wind energy generator. The second thermal generator 124 is connected to an energy generator side busbar 104-3. The second photovoltaic energy generator and a second wind energy generator are connected to a renewable energy generator side busbar 104-4.

Power generated by the thermal generator 124 is collected at a load busbar 104-12, while power from the second renewable energy unit 126 is gathered at a load busbar 104-13. The load busbars 104-12 and 104-13 deliver power to a busbar 104-14, which is then connected to load 128. The busbar 104-14 is also referred to as the second busbar or the second busbar 104-14. The load 128 represents various energy consumers within the second geographic region.

In one aspect, the second busbar 104-14 is connected to receive the power disturbances from each of the first electrical tie-line 12 and the third electrical tie-line 23. Referring to FIG. 5B, the second power system 104 also includes a frequency meter 528 configured to measure a frequency on each of the first electrical tie-line 12 and the third electrical tie-line 23 and generate a combined frequency measurement at adder 526. In FIG. 5B, the first electrical tie-line 12 and the third electrical tie-line 23 are shown as tie-lines 21 and 23 respectively, reflective of the direction of power flow. The second power system 104 further includes a first subtractor 530 configured to subtract the combined frequency measurement from a reference frequency 530 and generate a power to frequency ratio bias signal 540. The second power system 104 further includes an interchange scheduler 534 configured to generate a time window for an exchange of power from the second busbar 104-14 to the MPC-(1+PIDN) controller 508, which is connected to each of the power systems. Further, the second power system 104 includes a second subtractor 536 configured to receive the power disturbances from the second busbar and transmit the power disturbances at the scheduled time. The second power system 104 further includes a third subtractor 538 configured to subtract the power to frequency ratio bias signal from the scheduled power disturbances and generate an ACE₂ signal which is sent to the MPC-(1+PIDN) controller 508.

The third power system 106 of area-3 includes a combination of energy resources, including a third thermal generator 130, and a third renewable energy unit 132 integrating a photovoltaic energy generator and a wind energy generator. The third thermal generator 130 is linked to a traditional energy generator side busbar 106-5. The third photovoltaic energy generator and the third wind energy generator are connected to a renewable energy generator side busbar 106-6.

The traditional energy generator side busbar 106-5 channels the electricity produced by the third thermal unit 130 to a load busbar 106-15, while the renewable energy generator side busbar 106-6 channels electricity from the third renewable energy unit 132 to a load busbar 106-16. These load busbars 106-15 and 106-16 are responsible for delivering power to a third busbar 106-17, which supplies energy to load 134, servicing various consumers in the third geographic region. The busbar 106-17 is also referred to as the third busbar or the third busbar 106-17.

In one aspect, the third busbar 106-17 is connected to receive the power disturbances from each of the first electrical tie-line 12 and the third electrical tie-line 23. As shown in FIG. 5B, the third power system 106 also includes a frequency meter 548 configured to measure a frequency on each of the second electrical tie-line 13 and the third electrical tie-line 23 and generate a combined frequency measurement. In FIG. 5B, the second electrical tie-line 13 and the third electrical tie-line 23 are illustrated as tie-lines 31 and 32 respectively, reflective of the direction of power flow. The third power system 106 further includes a first subtractor 530 configured to subtract the combined frequency measurement from a reference frequency 532 and generate a power to frequency ratio bias signal 556. The third power system 106 further includes an interchange scheduler 550 configured to generate a time window for an exchange of power from the third busbar 106-17 to the MPC-(1+PIDN) controller 508. Further, the third power system 106 includes a second subtractor 536 configured to receive the power disturbances from the third busbar and transmit the power disturbances at the scheduled time. The third power system 106 further includes a third subtractor 538 configured to subtract the power to frequency ratio bias signal from the scheduled power disturbances and generate an ACE₃ signal.

The fourth power system 108 of area-4 is integrated with a set of energy resources, including a hydroelectric power generator 136 and a fourth renewable energy unit 138 including a photovoltaic energy generator and a wind energy generator. The hydroelectric power generator 136 is connected to a generator side busbar 108-7. The fourth photovoltaic energy generator and the fourth wind energy generator are connected to a renewable energy generator side busbar 108-8.

Electricity from the hydro generator 136 is directed to a load busbar 108-18, while the renewable energy units direct the power output to a load busbar 108-19. Power from these load busbars 108-18 and 108-19 is consolidated at a fourth busbar 108-20, which then feeds a load 140. The load 140 includes a variety of energy consumers located in the fourth geographic region. The busbar 108-20 is also referred to as the fourth busbar or the fourth busbar 108-20.

In one aspect, the fourth busbar 108-20 is connected to receive the power disturbances due to the fluctuation in the generation of power by the renewable energy generators 138 within area-4, fluctuations in demand from load 140 and from the fourth electrical tie-line 14. Referring to FIG. 5B, the fourth power system 108 includes a frequency meter 560 configured to measure a frequency on the fourth electrical tie-line 14 and generate a frequency measurement. In FIG. 5B, the fourth electrical tie-line 14 is illustrated as tie-line 41 respectively, reflective of the direction of power flow. The fourth power system 108 further includes a first subtractor 562 configured to subtract the combined frequency measurement from a reference frequency 564 and generate a power to frequency ratio bias signal 572. The fourth power system 108 further includes an interchange scheduler 566 configured to generate a time window for an exchange of power from the fourth busbar 108-20 to the MPC-(1+PIDN) controller 508. Further, the fourth power system 108 includes a second subtractor 568 configured to receive the power disturbances from the fourth busbar and transmit the power disturbances at the scheduled time. The fourth power system 108 further includes a third subtractor 570 configured to subtract the power to frequency ratio bias signal from the scheduled power disturbances and generate an ACE₄ signal.

Connectivity between the power systems is achieved through the network of electrical tie-lines. An electrical tie-line in power systems is a transmission line that connects two different power grids or systems. By such connection, power between the systems connected by the tie-line is exchanged in order to balance supply and demand across wider areas. The first electrical tie-line 12 is configured to connect the first power system 102 with the second power system 104, the second electrical tie-line 13 connects the first power system 102 with the third power system 106, a third electrical tie-line 23 interlinks the second power system 104 with the third power system 106, and a fourth electrical tie-line 14 connects the first power system 102 with the fourth power system 108.

Each power system 102, 104, 106, and 108 is further configured to produce and transmit the area control error (ACE) signals. ACE₁ is the ACE signal generated by the first power system, ACE₂ is the ACE signal generated by the second power system, ACE₃ is the ACE signal generated by the third power system, and ACE₄ is the ACE signal generated by the fourth power system. The ACE is a quantity used in operating bulk electric systems. The ACE is defined as the instantaneous difference between a balancing net actual and scheduled interchange with all adjacent interconnected balancing authority areas. The ACE is measured in megawatts (MW). The ACE signals, resultant from the aggregation of power deviations, offer a metric of discrepancy from the predetermined frequency set-point. The ACE signal is fed to the MPC-(1+PIDN) controller 508 of the LFC system 100 to analyze the deviations in supply and demand in the energy distribution network, and accordingly, to balance the power distribution in the grid and compensate for fluctuations in the power signals.

The ACE signals are configured as inputs for the MPC-(1+PIDN) controller 508 of the LFC system 100. As shown in FIG. 5A, the MPC is the first stage of the controller. The MPC is equipped with memory and a processor having processing capabilities to execute program instructions for the generation of a control signal u(k). The MPC is a controller based on logic that uses a mathematical model of a system to predict future behaviour and optimize control actions. At each time step, the MPC forecasts future outcomes based on current states and control inputs, then calculates the control inputs to achieve the desired performance according to a predefined objective function. In one example, the sampling time of the MPC is 0.1 seconds, the prediction horizon is 10 and the control horizon is 3.

The output of MPC, control signal u(k), is fed to a second stage of the controller. The second stage is configured with a one-plus proportional integral derivative (1+PIDN) controller. The 1+PIDN controller is operatively interconnected with the MPC, configured as a series of amplifiers with tunable gain parameters, which are dynamically updated by an optimizer. The 1+PIDN controller is configured to receive the control signal u(k) and the updated gain parameters and generate an output signal configured to mitigate power disturbances due to frequency imbalances on the first electrical tie line 12, the second electrical tie-line 23, the third electrical tie-line 13, and the fourth electrical tie-line 14.

The 1+PIDN controller is a type of controller that builds upon the proportional-integral-derivative (PID) control strategy. The “1+” indicates an additional component in the control structure, typically representing a filter configured for improving the robustness or performance of the controller.

The PIDN controller is a PID controller that includes a derivative filter, denoted by “N” to improve the derivative action. The derivative filter is used to mitigate the effects of noise in the derivative term, which can lead to erratic control signals. The PIDN controller thus enhances the ability of the classic PID controller to predict and compensate for future trends in the behavior of the system, which is particularly useful in systems with higher-order dynamics or where the derivative of the error signal is noisy.

When combined with an MPC, the 1+PIDN controller may be used to fine-tune the control actions based on the output of the predictive model, thereby providing both the predictive capabilities of the MPC and the reactive, compensatory actions of the PID controller with enhanced filtering through the derivative term. Thus, the controller, a combination of the MPC and the 1+PIDN controllers, results in a control system that can effectively anticipate system needs while maintaining stability and reacting to immediate changes in the behavior of the LFC system 100.

In one aspect, the LFC system 100 further includes an optimizer 504 operatively connected to the MPC. The optimizer is configured to receive the ACE signals, apply the ACE signals to a salp swarm algorithm which updates the gain parameters of the 1+PIDN controller 506. The controller, in one aspect, is configured to optimize the system by the salp swarm algorithm implemented to refine the gain parameters based on the received ACE signals.

The salp swarm algorithm is a computational algorithm inspired by the swarming behavior of salps in the ocean. Salps move in a swarm in a chain-like formation, a behavior that is translated into an algorithmic context to solve optimization problems. With reference to the present disclosure, the salp swarm algorithm is implemented to optimize the parameters of the 1+PIDN controller for adjusting power distribution across the power grid. In an example, if the frequency of the power grid starts to fall because demand is outstripping supply, the grid sensors would detect this and could send signals to increase the output of certain generators. Conversely, if the frequency rises above the nominal value due to an excess of supply over demand, the grid sensors would instruct some generators to scale back their output. The MPC-1+PIDN controller 508 in the LFC system 100 could be used to fine-tune these adjustments by predicting future system states and adjusting control inputs accordingly to ensure smooth, stable operation without oscillations or overshoots based on the salp swarm algorithm.

In the LFC system 100, as depicted in FIG. 1, each energy generation unit has a specific configuration of parameters for energy generation. Moreover, the grid also accounts for nonlinearities. Most of these nonlinearities are composed of a rate limiter and a generator rate constraint (GRC). Each energy unit can be described based on configurational parameters and nonlinearities computation. Each energy unit is described in the subsequent description.

The thermal unit includes components, such as the electrical generator, a governor, a steam turbine, and a reheater. The governor attached to the generator is configured to maintaining frequency stability during load imbalances. In one implementation of the present disclosure, in a model of the thermal system, an example of a combined power plant capacity of 2200 MW for each area, with a standard operational load of 2000 MW and one plant running at 1000 MW is used. The base power level is set at 1000 MVA.

The governor output ΔP_{gi}(s) is the difference of the reference power ΔP_{ref} and frequency change Δfᵢ(s) passed through droop control, 1/R is given as:

$$Δ {P}_{gi} ( s ) = Δ {P}_{ref} ( s ) - \frac{1}{R} Δ {f}_{i} ( s ) ; \qquad ( 1 )$$

Power transfer between the areas (i and j) can be summarized as:

$$Δ {P}_{tieij} = {\sum }_{j = 1}^{n} \frac{{T}_{ij}}{S} ( Δ {f}_{i} - Δ {f}_{j} ) ; i \neq j \qquad ( 2 )$$

Area central error (ACE) for each area is given by:

$${ACE}_{i} = {B}_{i} Δ {f}_{i} + Δ {P}_{tie , ij} ; i \neq j \qquad ( 3 )$$

where Bᵢ is the frequency bias factor parameter in p.u. of MW/Hz, and ΔP_{tie,ij} is the change of tie-line power between two areas i and j.

The output Δfᵢ is expressed as:

$$Δ {f}_{i} ( s ) = {G}_{p} ( s ) [ {\sum }_{j = 1}^{n} Δ {P}_{Rij} - Δ {P}_{d , i} - Δ {P}_{tie , i} ] ; where {G}_{p} ( s ) = \frac{1}{{M}_{i} s + {D}_{i}} \qquad ( 4 )$$

The fourth area comprises a hydroelectric power plant along with PV and wind energy resources. The hydroelectric power plant contributes to meeting the energy demand of the overall power generating system, while the PV and wind also contribute to meeting the energy demand. The nominal operation load on the hydroelectric power plant is 1000 MW, while the installed capacity of the hydro power plant is 2000 M W. The hydroelectric power plant exchanges power with the first geographic area-1 that is further connected with the second geographic area-2 and the third geographic area-3.

The hydro turbine transfer function is expressed as:

$${G}_{t} ( s ) = \frac{{K}_{r} {T}_{r} s + 1}{{T}_{r} s + 1} \cdot \frac{- {T}_{w} s + 1}{0.5 {T}_{w} s + 1} \qquad ( 5 )$$

For the fourth geographic area-4, the open loop transfer function can be written as:

$$G ( s ) = \frac{{K}_{p 4} ( {T}_{2} s + 1 ) ( - {T}_{w} s + 1 )}{( {T}_{1} s + 1 ) ( {T}_{3} s + 1 ) ( {T}_{4} s + 1 ) ( 0.5 {T}_{w} s + 1 )} \qquad ( 6 )$$

The model symbols along with their values are listed in Table 1.

TABLE 1
Model symbols

| Terminology | Symbols | Values | |
|---|---|---|---|
| Frequency bias factor | B₁, B₂, B₃, B₄ | 0.425 | MW/Hz |
| Speed regulation constant | R₁, R₂, R₃, R₄ | 2.4 | Hz/MW |
| Generator gain | Kₚ₁, Kₚ₂, Kₚ₃, Kₚ₄ | 120 | |
| | | 80 | |
| Generator time constant | Tₚ₁, Tₚ₂, Tₚ₃, Tₚ₄ | 20 | s |
| | | 13 | s |
| Governor time constant | T_{g1}, T_{g2}, T_{g3}, T₁ | 0.2 | s |
| | | 48.7 | s |
| Hydro turbine transmission | T₂, T₃ | 0.513 | s |
| coefficient | | 10 | s |
| Initial time constant for | T_{w} | 1 | s |
| water flow | | | |
| Reheat time constant | Tᵣ | 20 | s |

| | | |
|---|---|---|
| Reheat gain | Kᵣ | 0.333 |

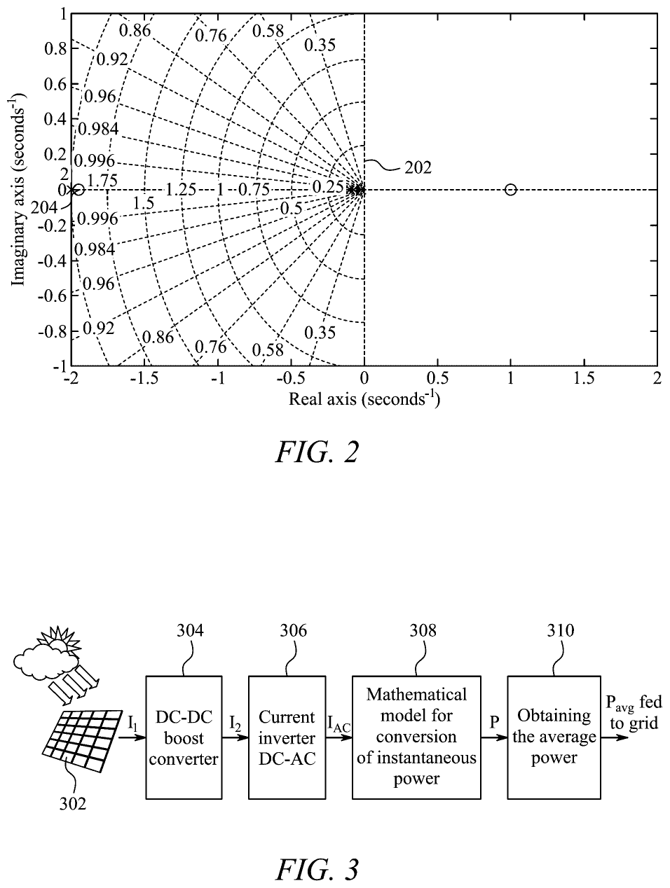

FIG. 2 illustrates a pole-zero map of the MPC one plus proportional integral derivative (1+PIDN) controller 508 implemented for the fourth power system corresponding to the fourth geographic area. The graphical representation elucidates the control system dynamics by displaying the system poles, denoted by ‘X’, and zeros, denoted by ‘O’.

In the pole-zero map, the zero 202 is located on the right half of the plane, indicating a non-minimum phase element within the system. The non-minimum phase element is an indicative of instability. Correspondingly, the pole 204, situated on the left half of the plane, typically contributes to stability of the system.

The LFC system 100, including the MPC-(1+PIDN) controller 508, is adapted to address the stabilization challenges posed by the system dynamics identified in FIG. 2. The MPC, which receives area control error (ACE) signals, and the 1+PIDN controller, with gain parameters updated by an optimizer which applies a salp swarm algorithm, function collaboratively to produce control signals capable of compensating for power imbalances.

This configuration ensures the robust control necessary for the stability of the entire four-area system, inclusive of the renewable and traditional energy sources within the power system. The pole-zero map is considered in the design and implementation to provide the requisite information for configuration of the LFC system 100 to maintain the stability of the power across all interconnected areas.

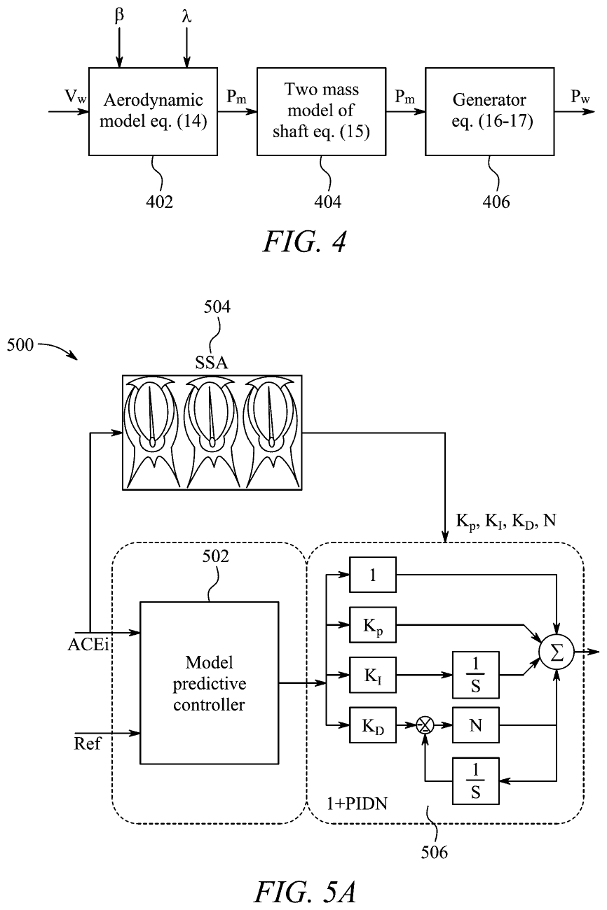

FIG. 3 illustrates a block diagram of a photovoltaic (PV) system interconnected to the load frequency control LFC system 100 for a multi-region power system.

The photovoltaic system comprises a photovoltaic panel 302, which serves as a direct current (DC) nonlinear output source. The photovoltaic panel 302 may represent an array of photovoltaic panels, for example, a field of photovoltaic panels. The performance of the photovoltaic panel 302 is contingent on solar irradiation, which can vay due to atmospheric conditions, as illustrated by the presence of both the sun and clouds. This variability impacts the design and operation of the PV system within the power system, particularly considering the need to integrate with other energy sources in a stable and efficient manner.

To facilitate the integration of the PV generation into the power system, the PV model includes several conversion units. The initial stage of conversion is handled by a DC-DC boost converter 304, which receives the direct current (I₁) from the photovoltaic panel 302. The DC-DC boost converter 304 is configured for stepping up the voltage level to match the requirements of the subsequent power conversion stages.

Following this, the DC power (I₂) is conveyed to a current inverter DC-AC 306, which converts the direct current into alternating current (I_{AC}). This conversion is essential for integrating the DC power produced by the photovoltaic panel 302 into the predominantly AC power grid.

The alternating current is then processed through a computation model 308 for conversion of instantaneous power, which is implemented to translate the alternating current into an immediate measure of power (P).

The PV system includes a subsystem 310 for obtaining the average power, which calculates the average power (P_{avg}) output to be fed into the grid. This average power reflects the overall performance of the PV system over time, smoothing out the fluctuations inherent in instantaneous power measurements due to the varying input from solar irradiation.

Each component of the PV system is configured to ensure that the photovoltaic system operates at maximum efficiency, transforming the variable DC power into stable AC power suitable for grid integration. The design and configuration of the PV system, as described, are vital for achieving the objectives of the load frequency control system as claimed, providing a reliable and consistent energy source within the larger multi-region power system.

In the PV model of FIG. 3, the PV is considered to be operating at its maximum power point. The transfer function of the boost converter is given as:

$${g}_{1} ( s ) = \frac{1}{{m}_{1}} \qquad ( 7 )$$

where m₁ is:

$${m}_{1} = \frac{{v}_{2}}{{v}_{1}} = \frac{{i}_{1}}{{i}_{2}} \qquad ( 8 )$$

Similarly, the inverter transfer function is denoted as:

$${g}_{2} ( s ) = \frac{{I}_{a c} ( s )}{{I}_{2} ( s )} = \frac{{s}^{2}}{{s}^{2} + {ω}^{2}} \qquad ( 9 )$$

where ω=2πf=2π(50)=314.12 rad/(sec.)

The transfer function of the instantaneous power is given as:

$$P ( s ) = \frac{{v}_{m} {i}_{m}}{2 s} + \frac{{v}_{m} {i}_{m}}{2} \frac{s}{{s}^{2} + {( 2 ω )}^{2}} \qquad ( 10 )$$

where, m represents the mean, i.e., the mean voltage vₘ an the mean current iₘ.

The gain of the instantaneous power is provided as:

$${g}_{3} ( s ) = \frac{p ( s )}{{I}_{a c} ( s )} = {v}_{m} ( \frac{( {s}^{2} + {ω}^{2} ) ( {s}^{2} + {( 2 ω )}^{2} )}{{s}^{2} ( {s}^{2} + {( 4 ω )}^{2} )} ) \qquad ( 11 )$$

The average power is expressed as:

$${p}_{a v g} ( s ) = \frac{{v}_{m} {i}_{m}}{2 s} \qquad ( 12 )$$

and the average power gain is described as:

$${g}_{4} ( s ) = \frac{{p}_{avg} ( s )}{p ( s )} \qquad ( 13 )$$

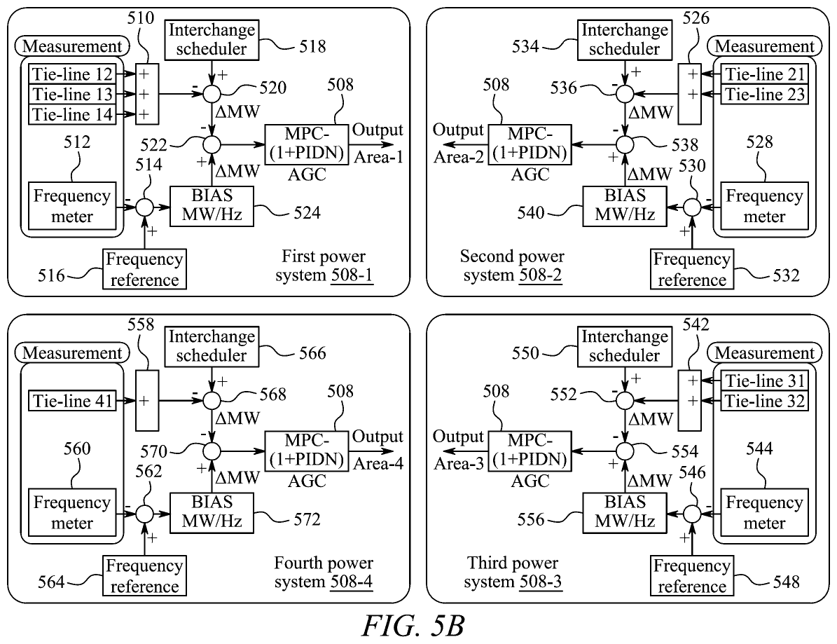

FIG. 4 illustrates a schematic representation of the wind energy unit, in accordance with the present disclosure. The wind energy conversion model is designed to address the complexities of integrating wind energy into a multi-region power system.

The model begins with the wind velocity Vw, an input to the aerodynamic model block 402, where β represents the blade pitch angle and λ the tip speed ratio. The aerodynamic model, defined by equation (14), computes the mechanical power Pm based on these inputs, which characterizes the energy captured from the wind.

The mechanical output power of the wind turbine (WT), including the wake effect is expressed as:

$${P}_{w} = \frac{1}{2} ρ {A}_{T} {C}_{p} ( λ , β ) {V}_{wake}^{3} \qquad ( 14 )$$

$$where ,$$

$$\{ \begin{matrix}{V}_{wake} = {V}_{m} [ 1 - {\sum }_{i = 1}^{n} ( 1 - \sqrt{( 1 - \frac{{F}_{T}}{ρ π {r}^{2} {V}_{m}^{2}} )} ) {( \frac{r}{r + k Δ x} )}^{2} ] \\ {C}_{p} ( λ , β ) = {C}_{1} ( \frac{{C}_{2}}{{C}_{I}} - {C}_{3} β - {C}_{4} ) {e}^{\frac{- {C}_{5}}{{λ}_{I}}} + {C}_{6} {λ}_{T} \\ \frac{1}{{λ}_{I}} = \frac{1}{λ + 0.08 β} - \frac{0.035}{{β}^{3} + 1} ; {λ}_{T} = \frac{{w}_{r} r}{{V}_{w}} ; {A}_{T} = \frac{π {d}^{2}}{4}\end{matrix}$$

where Cₚ is the power coefficient, β is the blade pitch angle, and ρ denotes the air density (Kg/m\hat{ }3). The rotor diameter is represented by d (m), and the tip speed ratio (TSR) is denoted by λ_{T} and λ_{I} is the intermittent TSR. F_{T} is a thrust force, k denotes the decreasing coefficient (for onshore WT, k=0.075, and for offshore WT, k=0.05), Δx is the distance between two consecutive WTs, and V_{w} is the effective wind velocity.
   From the aerodynamic model block 402, the mechanical power Pm flows into the two-mass model of the shaft block 404. This model, governed by equation (15), captures the dynamic behavior of the wind turbine shaft, considering the mass and elasticity of the shaft system that transfers the mechanical energy from the turbine blades to the generator.

The two-mass model of the gear coupling is represented as:

$$\{ \begin{matrix}{\dot{ω}}_{W T} = - ( \frac{{D}_{W T} + {D}_{shaft}}{{J}_{W T}} ) {ω}_{r , WT} + \\ ( \frac{{D}_{shaft}}{{J}_{W T}} ) {ω}_{g e n} - ( \frac{1}{{J}_{W T}} ) {T}_{int} + ( \frac{1}{{J}_{W T}} ) d ( t ) \\ {\dot{ω}}_{gen} = ( \frac{{D}_{shaft}}{2 {J}_{W T}} ) {ω}_{r , W T} + ( \frac{{D}_{g e n} + {D}_{shaft}}{{J}_{g e n}} ) \\ {ω}_{g e n} - ( \frac{1}{{n}_{gear} {J}_{gen}} ) {T}_{int} + ( \frac{1}{{J}_{g e n}} ) u ( t ) \\ {\dot{T}}_{int} = {K}_{shaft} ( {ω}_{W T} - \frac{{ω}_{g e n}}{{n}_{g e a r}} )\end{matrix} \qquad ( 15 )$$

where J_{WT} and J_{gen} represent WT moment of inertia of the rotor and generator, respectively. Shaft internal torque is represented by Tᵢₙₜ, WT rotor and generator speed is denoted by ω_{r,WT}, and gear turns ratio is represented by n_{gear}. D_{shaft} and D_{gen} are the damping constant of the WT, coupling shaft and generator, respectively.

The mechanical power Pm output from the two-mass shaft model block 404 is then input into the generator block 406. This block is defined by equations (16-17) and represents the conversion of mechanical energy into electrical power Pw, which is the final output of the wind energy conversion process and is fed into the power grid.

Assuming the output power P_{w} is ideal and the generator is lossless, the equations are:

$${P}_{w} = {T}_{gen} {ω}_{g} ; \qquad ( 16 )$$

$$\frac{{dT}_{gen}}{dt} = ( - \frac{1}{{τ}_{gen}} ) {T}_{gen} + ( \frac{1}{{τ}_{gen}} ) {T}_{contol} ; \qquad ( 17 )$$

where τ_{gen} denotes the time constant of the generator, and T_{contol} represents the control torque that manipulates the output power of the WT against uncertain wind speed.

The precise modeling of each stage of the wind energy conversion model, as illustrated, ensures that the wind energy contribution to the power system is accurately controlled to mitigate the effects of wind variability on the frequency stability of the power system.

FIG. 5A illustrates a schematic diagram of the LFC system 500 which integrates a MPC 502 with a 1+proportional integral derivative number (1+PIDN) controller 506, in accordance with the present disclosure. The LFC system 500 is implemented to manage the stability and distribution of power within a multi-region power system.

The MPC 502, as described earlier with reference to FIGS. 1 and 5B, is a controller that receives the ACE of each area as an input, in addition to a predefined reference signal. With the inputs, the MPC 502 is configured to execute a cost-minimization strategy that respects operational constraints. The MPC controller 502 is implemented for forecasting the system behavior and adjusting control efforts proactively to maintain the desired power system equilibrium.

The MPC controller 502 includes three blocks. First, a predictive block; second, an optimization solver; and third, a cost function block. The predictive model captures the relationship between the system's inputs, outputs, and internal states. It forecasts how the system will respond to different control actions and disturbances. The predictive block utilizes a dynamic model of the system to predict its future behavior over a defined time horizon. Based on the future behavior of the system, the MPC controller 502 formulates an optimization problem to determine the optimal control actions that minimize or maximize a certain objective function over the prediction horizon while satisfying system constraints. The optimization solver finds the control inputs that achieve a best trade-off between performance and constraint satisfaction. The cost function block defines ab objective that the MPC controller 502 seeks to optimize. The cost function block quantifies a desired performance criteria, such as minimizing energy consumption, maximizing production, or tracking a reference trajectory. The cost function includes terms that penalize deviations from setpoints, control effort, and violation of constraints.

The cost function is applied to the SSA to be minimized.

The cost function J_{ITAE} is an integral time absolute error given by:

$${J}_{ITAE} = {\int }_{0}^{{T}_{sin}} t ( \vert {ACE}_{1} ( t ) \vert + \vert {ACE}_{2} ( t ) \vert + \vert {ACE}_{3} ( t ) \vert + \vert {ACE}_{4} ( t ) \vert ) dt$$

where t is time, ACE₁ is the ACE signal generated by the first power system, ACE₂ is the ACE signal generated by the second power system, ACE₃ is the ACE signal generated by the third power system, ACE₄ is the ACE signal generated by the fourth power system. ITAE is defined as the integral time-weighted absolute error.

The function of these blocks is to shift the system response towards the reference trajectory based on the past and future predictions.

The output predictive vector is represented by Yₚ₍ₖ₎ as:

$${Y}_{p} ( k ) = ϕ Z ( k ) + ψ Δ U ( k ) + {ψ}_{I} Δ {U}_{I} ( k ) \qquad ( 18 )$$

The control law is obtained by the gradient descent method, i.e., (∂J(k))/ΔU₍ₖ₎=0. To obtain the control law u(k) t the following equations are applied:

$$Δ U ( k ) = {( {ψ}^{T} Q ψ + R )}^{- 1} {ψ}^{T} Q ( {Y}_{r} ( k ) - ϕ Z ( k ) - {ψ}_{I} Δ {U}_{I} ( k ) ) \qquad ( 19 )$$

$$Δ u ( k ) = ( {E}_{{N}_{u}} {O}_{{N}_{u} ( P - 1 )} ) Δ U ( k ) \qquad ( 20 )$$

$$u ( k ) = Δ u ( k ) + u ( k - 1 ) \qquad ( 21 )$$

In the design of the cost function for the LFC problem, the constraint for the MPC is expressed as:

$$min J ( k ) = min \{ {( {Y}_{p} ( k ) - {Y}_{r} ( k ) )}^{T} Q ( {Y}_{p} ( k ) - {Y}_{r} ( k ) ) + {( Δ u ( k ) )}^{T} R ( Δ u ( k ) ) \} \qquad ( 22 )$$

The parameters Q and R are the weighting vectors to balance the square future control and performance predictive error.

The optimization of the control parameters is conducted by the salp swarm algorithm 504. The algorithm adjusts the control gains parameters, including proportional gain (Kp), integral gain (Ki), derivative gain (Kd), and a filter coefficient (N). The gain parameters define the responsiveness and stability of the 1+PIDN controller 506.

The control signal u(k) that is the output of the MPC is fed to (1+PIDN), and the (1+PIDN) controller processes the optimal signal of the MPC to further refine the signal to achieve the optimal control output for the LFC calculation, given by:

$$output = ( 1 + {K}_{P} + \frac{{K}_{I}}{s} + \frac{{K}_{D} Ns}{N + s} ) \times u ( k ) \qquad ( 23 )$$

where u(k) is the output signal of the MPC.

The 1+PIDN controller 506 integrates the gain parameters into its control logic. The proportional gain (Kp) modulates response of the controller proportionally to the error signal, offering immediate corrective action. The integral gain (K_{I}) addresses the accumulation of past errors, resulting in the elimination of residual steady-state errors. The derivative gain (Kd) provides a predictive control action based on the rate of change of the system error, enhancing the ability of the system to anticipate future errors. Finally, the filter coefficient (N) is applied to the derivative term to mitigate the impact of high-frequency noise on the control signal, refining the control action for a smoother system response.

Together, the components of the 1+PIDN controller 506 operate in concert to expedite the control process, effectively reducing settling time of the system and adeptly managing frequency disruptions. The controller design, detailed in FIGS. 5A, 5B, emphasizes not only the individual contributions of each control parameter but also their collective impact on performance of the system, ensuring rapid and robust load frequency control in a complex, interconnected power system environment.

FIG. 5B illustrates the configuration of a load frequency control system designed for four interconnected power systems, each situated within a separate geographic region.

In the first power system 508-1, the busbar 510 is the point of convergence for power disturbances from tie-lines 12, 13, and 14. A frequency meter 512 is configured for measuring frequency across these tie-lines and creating an aggregate frequency measurement. A first subtractor 514 receives the aggregate frequency measurement and compares the aggregate frequency measurement to a frequency reference signal 516 to generate a power to frequency ratio bias signal 524. An interchange scheduler 518 is configured to establish the timing for a power transfer from the busbar 510 to the MPC-(1+PIDN) controller 508. Following this, a second subtractor 520 processes the disturbances from the busbar 510, scheduling the disturbances based on the plan of the interchange scheduler 518. A third subtractor 522 receives the power to frequency ratio bias signal 524 and subtracts the scheduled power disturbances to produce the automatic generation control signal (AGC).

In the second power system 508-2, the busbar 526 is the point of convergence for power disturbances from tie-lines 21 and 23. A frequency meter 528 is configured for measuring frequency across these tie-lines and creating an aggregate frequency measurement. A first subtractor 530 receives the aggregate frequency measurement and compares the aggregate frequency measurement to a frequency reference signal 532 to generate a power to frequency ratio bias signal 540. An interchange scheduler 534 is configured to establish the timing for a power transfer from the busbar 526 to the MPC-(1+PIDN) controller 508. Following this, a second subtractor 536 processes the disturbances from the busbar 526, scheduling the disturbances based on the plan of the interchange scheduler 534. A third subtractor 522 receives the power to frequency ratio bias signal 540 and applies it to the scheduled power disturbances to produce the AGC.

In the third power system 508-3, the busbar 542 is the point of convergence for power disturbances from tie-lines 31 and 32. A frequency meter 544 is configured for measuring frequency across these tie-lines and creating an aggregate frequency measurement. A first subtractor 546 receives the aggregate frequency measurement and compares the aggregate frequency measurement to a frequency reference signal 548 to generate a power to frequency ratio bias signal 556. An interchange scheduler 550 is configured to establish the timing for a power transfer from the busbar 542 to the MPC-(1+PIDN) controller 500. Following this, a second subtractor 552 processes the disturbances from the busbar 542, scheduling the disturbances based on the plan of the interchange scheduler 550. A third subtractor 554 receives the power to frequency ratio bias signal 556 and applies it to the scheduled power disturbances to produce the AGC.

In the fourth power system 508-4, the busbar 558 is the point of convergence for power disturbances from a tie-line 41. A frequency meter 560 is configured for measuring frequency across these tie-lines and creating an aggregate frequency measurement. A first subtractor 562 receives the aggregate frequency measurement and compares the aggregate frequency measurement to a frequency reference signal 564 to generate a power to frequency ratio bias signal 572. An interchange scheduler 566 is configured to establish the timing for a power transfer from the busbar 558 to the MPC-(1+PIDN) controller 508. Following this, a second subtractor 568 processes the disturbances from the busbar 558, scheduling the disturbances based on the plan of the interchange scheduler 566. A third subtractor 570 receives the power to frequency ratio bias signal 572 and applies to the scheduled power disturbances to produce the AGC.

Each of these power systems integrates an MPC-(1+PIDN) configuration, demonstrating an advanced system devised to ensure the efficient management of frequency and power distribution across an interconnected network.

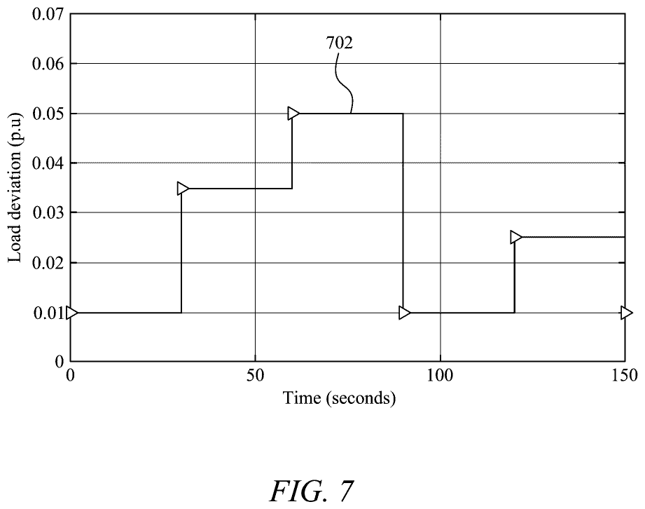

FIG. 6 illustrates a flowchart of a method for implementing the salp swarm algorithm (SSA) with a MPC combined with a 1+Proportional Integral Derivative plus Number (1+PIDN). In a non-limiting example, the method is described as simulated with a Simulink model in MATLAB 2017a, using a CoreTMi7 CPU at 2.2 GHZ and 8 GB of RAM. The SSA implementation contributes to the robust load frequency control in a multi-region power system.

At step 602, the sequence is initiated. Next, step 604 integrates the Simulink model with SSA MATLAB code, establishing a computational foundation for the optimization process. At step 606, the SSA controlling parameters are specified, which will guide the search process within the algorithm, by programming the Simulink model with the cost function J_{ITAE} and entering the parameters for the salps, such as velocity and initial position. At step 608, the initial population is generated randomly, providing a diverse set of potential solutions from which the algorithm can commence the optimization. At step 610, the fitness function for each salp is evaluated, and the algorithm determines the salp according to the defined fitness criteria, which the cost function J_{ITAE} based on the area control error (ACE) values of each area within the power system. Step 612 involves updating the value of coefficient C1 using the predefined equation (25), an action that adjusts the search behavior of the algorithm in the solution space. The iterative process of the algorithm is handled in steps 614 through 630. Within this loop, the positions of the leading and following salps are updated in steps 618 and 620, respectively, utilizing equations (24) and (26) to refine their locations in the search space based on the fitness evaluations. The position of each salp is recorded at step 622, providing a historical record of progression of the algorithm. The iterative loop continues with a check at step 624 to determine whether all salps have been evaluated in the current iteration. Upon reaching the maximum number of iterations, as evaluated at step 628, the optimized model parameters are displayed at step 632, signifying the conclusion of optimization phase of the algorithm. The model is then simulated with the obtained optimal parameters at step 634, ensuring that the system operates according to the optimized settings. Finally, step 636 compares the results with well-known methods in the literature for validation to evaluate the performance of the SSA-optimized MPC-(1+PIDN) controller. Such comparison serves to substantiate the efficacy of the controller design in managing the load frequency control problem within the interconnected power system.

The salp swarm optimization algorithm is designed from the transparent bodied salp which transforms itself into a chain-like structure during the search for food. The salp swarm algorithm is mainly comprised of two sections: (i) leader and (ii) followers. The salp swarm algorithm is translated in the form of a block diagram shown in FIG. 6.

The leader movement of the SSA is decided by:

$${K}_{j}^{i} = \{ \begin{matrix}{M}_{i} + {C}_{1} ( ( {ub}_{j} - {lb}_{j} ) {C}_{2} + {lb}_{j} ) , & {C}_{3} \geq 0 \\ {M}_{i} - {C}_{1} ( ( {ub}_{j} - {lb}_{j} ) {C}_{2} + {lb}_{j} ) , & {C}_{3} < 0\end{matrix} ; \qquad ( 24 )$$

where M and K signify the target food and two-dimensional salp position, respectively. ubⱼ and Ibj denote the respective upper and lower bounds of the j^{th} dimension. Similarly, C₂ and C₃ are uniform coefficient numbers and C₁ is further expressed as:

$${C}_{1} = 2 {e}^{- {( \frac{4 t}{{t}_{max}} )}^{2}} ; \qquad ( 25 )$$

where t denotes the current iteration and tₘₐₓ signifies the maximum number of iterations. The position is updated by:

$${K}_{j}^{i} = \frac{1}{2} {at}^{2} + {v}_{0} t ; s \qquad ( 26 )$$

where, K represents gain parameters.

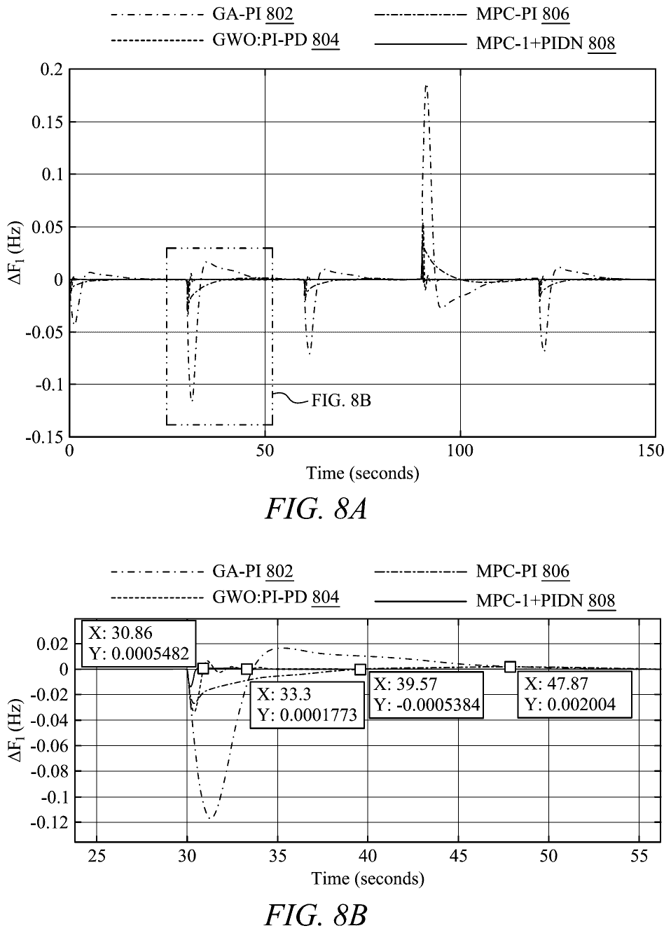

FIG. 1 to FIG. 6 illustrate the LFC system for a multi-region power system incorporating a plurality of renewable energy sources. The LFC system was simulated in MATLAB 2017a, using a CoreTMi7 CPU at 2.2 GHz and 8 GB of RAM. The simulation results are depicted in FIG. 7 through FIG. 26.

In the simulation environment, the various algorithms of GA, GWO, SSA, and MPC were initialized, and the initial algorithm parameters configuration details are stated in Table 2.

TABLE 2
Algorithms parameters setting

| Algorithm | Parameters |
|---|---|
| GA | Population size = 50, maximum |
| | generations = 100, crossover |
| | probability = 0.75, mutation |
| | probability = 0.1. |
| GWO | Wolf number = 50, |
| | maximum iteration = 100, |
| | α = 0.7, |
| | γ = 0.9 |
| SSA | Population size = 50, |
| | maximum iteration = 100, |
| | C2 = 0.5, |
| | C3 = 0.5 |
| MPC | Prediction horizon P = 3, |
| | control horizon M = 2, |

Further, the optimized controller parameters for the four-area based power system are formulated in Table 3.

TABLE 3
Optimized controller parameters

| Controller | | | | MPC- |
|---|---|---|---|---|
| Parameters | GA-PI | GWO:PI-PD | MPC/PI | (1 + PIDN) |
| Area-1 | K_{P} = −0.6130 | K_{P} = −2.823 | K_{P} = 0.12 | K_{P} = 4.89 |
| | K_{I} = −0.8010 | K_{I} = −2.789 | K_{I} = 0.81 | K_{I} = 7.710 |
| | | K_{P} = −3.084 | | K_{D} = 0.0148 |
| | | K_{D} = −1.997 | | N = 300 |
| Area-2 | K_{P} = −0.6911 | K_{P} = −2.902 | K_{P} = 0.17 | K_{P} = 7.310 |
| | K_{I} = −0.7665 | K_{I} = −3.627 | K_{I} = 0.92 | K_{I} = 12.927 |
| | | K_{P} = −3.084 | | K_{D} = 0.102 |
| | | K_{D} = −0.982 | | N = 300 |
| Area-3 | K_{P} = −0.6025 | K_{P} = −3.1240 | K_{P} = 0.20 | K_{P} = 2.267 |
| | K_{I} = −0.7901 | K_{I} = −3.1121 | K_{I} = 0.32 | K_{I} = 6.126 |
| | | K_{P} = −3.0401 | | K_{D} = 0.0241 |
| | | K_{D} = −0.8012 | | N = 300 |
| Area-4 | K_{P} = −0.6611 | K_{P} = −2.8114 | K_{P} = 0.11 | K_{P} = 6.589 |
| | K_{I} = −0.8021 | K_{I} = −3.6101 | K_{I} = 0.41 | K_{I} = 12.106 |
| | | K_{P} = −3.1144 | | K_{D} = 0.0015 |
| | | K_{D} = −1.1212 | | N = 300 |

FIG. 7 illustrates a graphical representation of abrupt load deviations over time. The abrupt deviations are calculated to assess the performance of the control technique under high-order areas (HOA) within a power system.

FIG. 7 plots load deviation (p.u.) on the vertical axis against time (seconds) on the horizontal axis. Notably marked by reference number 702, the plotted step changes indicate instances of load perturbation introduced to test the robustness of the control system. These deviations range from 1% to 5%, with the upper limit representing a severe condition in load variation. The depicted step changes, line 702, simulates the dynamics of the power system and the response of the controller to such fluctuations.

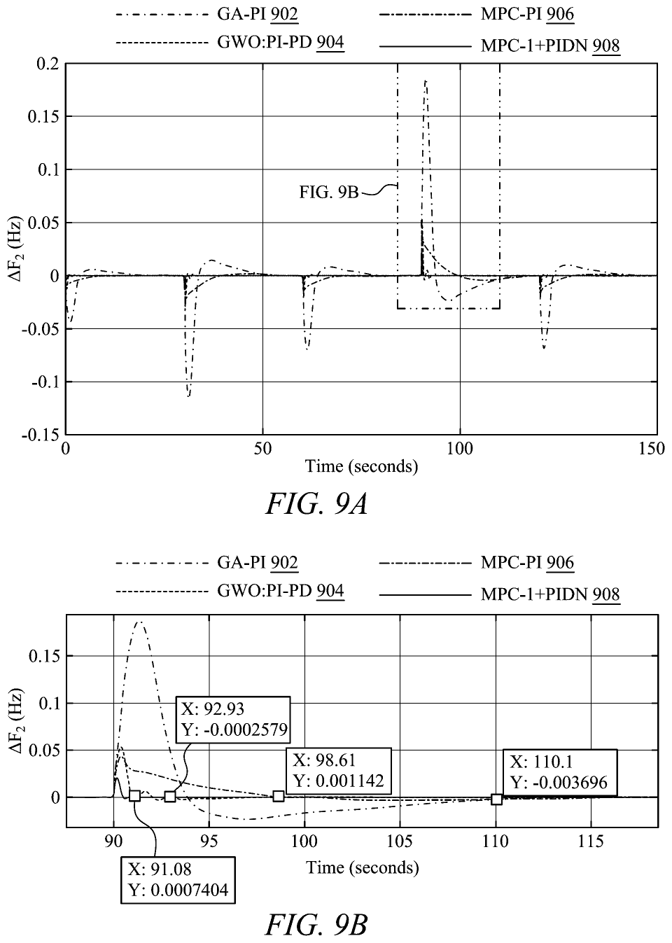

FIG. 8A illustrates the frequency response of the controller configured for the first geographic area within a multi-area power system. The frequency response determines the comparison of the performance of various controllers, including the MPC-(1+PIDN) controller. In the graph, the vertical axis represents the frequency deviation in per unit (p.u.) and the horizontal axis denotes the time in seconds.

FIG. 8A displays several response curves, each corresponding to different controller configurations. A curve 802 corresponds to a genetic algorithm-proportional integral (GA-PI) controller. A curve 804 is the response of a grey wolf optimizer-proportional integral derivative (GWO-PID) controller. A curve 806 corresponds to a firefly algorithm-proportional integral Derivative (FA-PID) controller. A curve 808 denotes the response of the MPC-(1+PIDN) controller.

The dashed section is an area of particular interest, and is enlarged in FIG. 8B for detailed analysis. Within this region, transient behaviors of the control systems under load variations are magnified, providing insight into the comparative effectiveness of the controllers under test conditions.

The MPC-(1+PIDN) controller demonstrates enhanced stability and a rapid return to the nominal frequency value following a disturbance, which is characterized by its curve marked with reference number 808. Such performance is indicative of the of the controller and ability to maintain system equilibrium under varying load conditions.

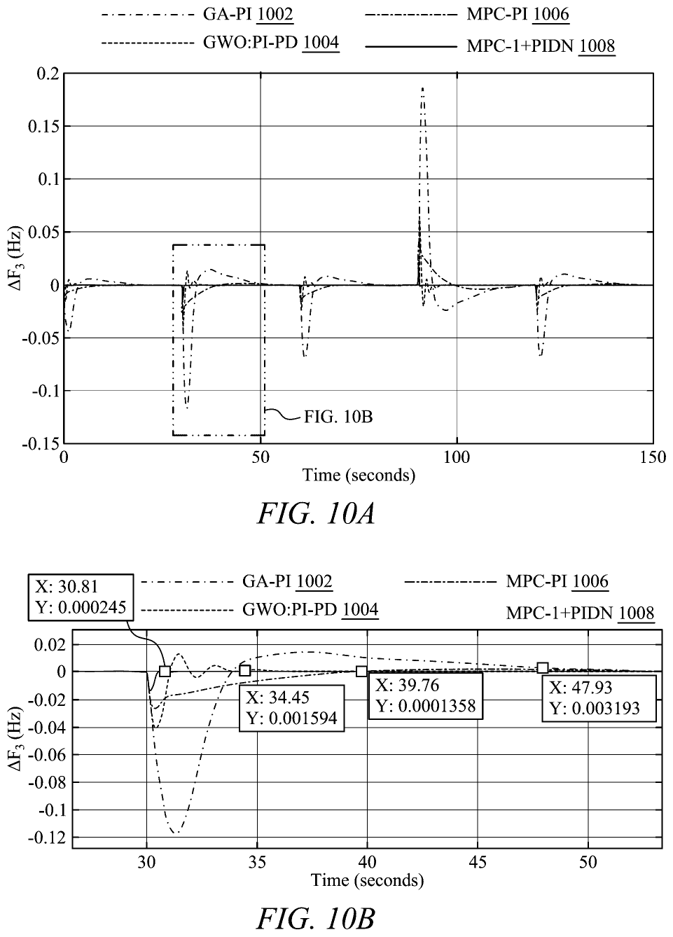

FIG. 9A presents the frequency response of the controller implemented for the second geographic area. As with FIG. 8A, the response curves of various controllers are plotted to demonstrate their efficacy in stabilizing frequency deviations.

A curve 902 depicts the response of the GA-PI controller. A curve 904 represents the GWO-PID controller. A curve 906 corresponds to the FA-PID controller. A curve 908 depicts the response of the MPC-(1+PIDN) controller, highlighting its performance.

The dashed section is an area of particular interest, which is enlarged in the FIG. 9B. The lower section is a detailed view of the transient response phase, where effectiveness the control strategies in mitigating frequency excursions is evaluated. Response curve 908 of the MPC-(1+PIDN) controller illustrates its ability to dampen oscillations and quickly restore system frequency to its desired value following a load change.

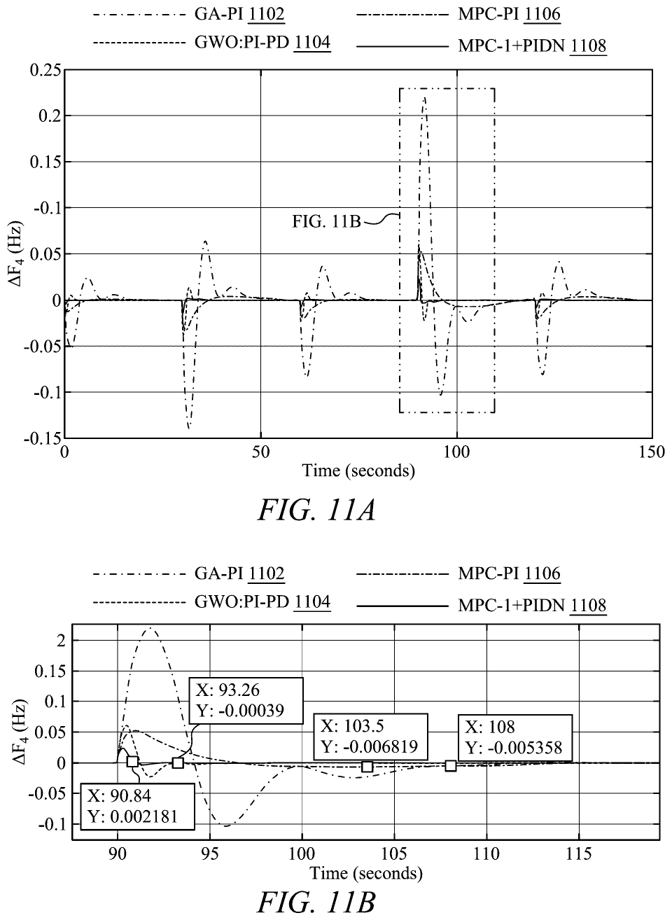

FIG. 10A illustrates the frequency response of the controller implemented for the third geographic area, examining the load frequency control capabilities of the MPC-(1+PIDN) controller in comparison to other algorithms.

The graph in FIG. 10A includes response curves for the various control strategies tested. Curve 1002 corresponds to the GA-PI controller. Curve 1004 signifies the GWO-PID controller. Curve 1006 represents the FA-PID controller. The response of the MPC-(1+PIDN) controller is shown with curve 1008.

Within the graph, the dashed section is an area of particular interest, which focuses on transient performance, where the control methodologies are subjected to abrupt load changes. The response curve this area is enlarged and presented in FIG. 10B. The response 1008, pertaining to the MPC-(1+PIDN) controller, shows a reduction in overshoot and a swift stabilization period, evidencing efficiency of the controller.

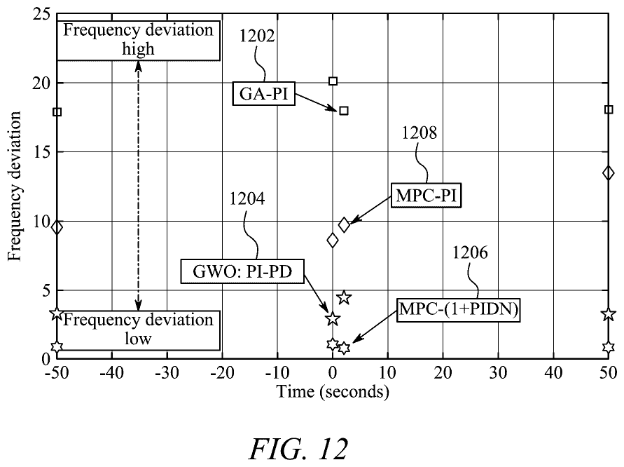

FIG. 11A depicts the frequency response of the MPC-(1+PIDN) controller for the fourth geographic area, especially in managing the complexities introduced by the right half-plane zero in the system.

Response curves for different control strategies are plotted against time. Curve 1112 shows the response of the GA-PI controller. Curve 1114 illustrates the GWO-PID controller response. Curve 1116 represents the FA-PID controller response. Response of the MPC-(1+PIDN) controller is depicted by curve 1118.

The dashed section is an area of particular interest as is the response curve that reflects behaviour of the system in reaction to significant load perturbations. The response curve for the dashed area is enlarged in FIG. 11B. The MPC-(1+PIDN) controller response, is indicated by curve 1118 that demonstrates robust control capability of the controller, particularly in achieving rapid stabilization of frequency post-disturbance.

The results of the simulations are compiled to analyze the effectiveness of the MPC-(1+PIDN) controller and to compare with other state-of-the-art controllers as listed in Table 4.

TABLE 4
Performance analysis of the different controllers

| | MPC-(1 + PIDN) | | | GWO:PI-PD | | | MPC/PI | | | GA-PI | | |
|---|---|---|---|---|---|---|---|---|---|---|---|---|
| Controller | S.T | U.S | O.S | S.T | U.S | O.S | S.T | U.S | O.S | S.T | U.S | O.S |
| Area-1 | 0.86 | −0.001 | 0 | 3.3 | −0.03 | 0.01 | 9.57 | −0.03 | 0 | 17.87 | −0.18 | 0.01 |
| Area-2 | 1.08 | 0 | 0.01 | 2.93 | 0 | 0.05 | 8.61 | 0 | 0.04 | 20.1 | −0.01 | 0.18 |
| Area-3 | 0.81 | −0.01 | 0 | 4.45 | −0.04 | 0.01 | 9.76 | −0.02 | 0 | 17.93 | −0.18 | 0.01 |
| Area-4 | 0.84 | 0 | 0.02 | 3.26 | −0.02 | 0.06 | 13.5 | −0.006 | 0.05 | 18 | −0.12 | 0.24 |

In Table 4, S.T represents the response time, U.S represents the undershoot amplitude and O.S represents the overshoot amplitude.

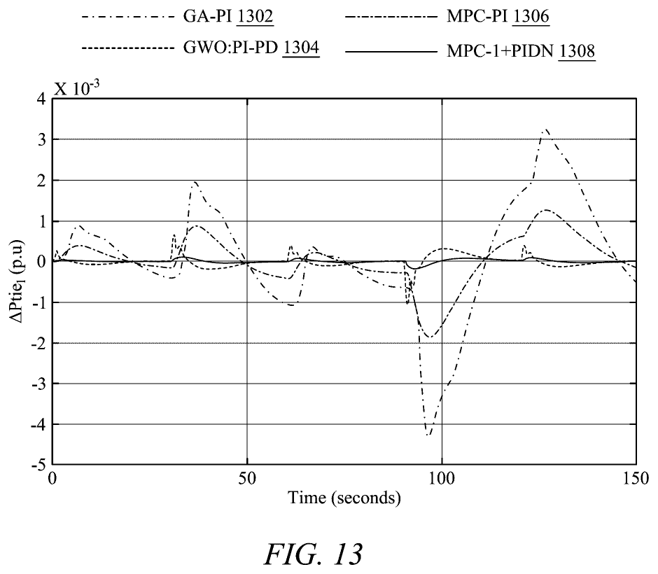

FIG. 12 depicts a frequency deviation graph comparing the performance of various controllers within a power system. The vertical axis measures frequency deviation in per unit (p.u.), and the horizontal axis represents time in seconds.

FIG. 12 includes four distinct data plots. The first plot 1212, illustrates the frequency response of the Genetic Algorithm-Proportional Integral (GA-PI) controller, showing significant high frequency deviation. The second plot 1214, shows the response for the Grey Wolf Optimizer-Proportional Integral Derivative (GWO-PI-PD) controller with frequency deviation at lower magnitudes. The third plot 1218, represents the frequency response of the Model Predictive Control-Proportional Integral (MPC-PI) controller. The fourth plot 1216, demonstrates the frequency response for the MPC-(1+PIDN) controller, exhibiting minimal frequency deviation, which approaches zero.

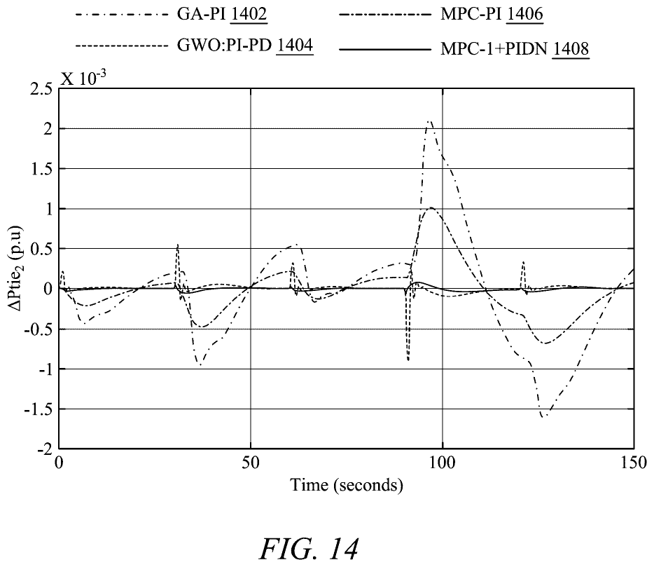

FIG. 13 illustrates the tie-line 12 power-sharing response of the various controllers implemented within the first power system, comparing the MPC-(1+PIDN) controller of the disclosure against other conventional techniques.

FIG. 13 includes four line plots representing different control strategies, each annotated with a unique reference number for identification. A curve 1312 corresponds to the GA-PI controller, a curve 1314 to the GWO-PI-PD controller, a curve 1318 to the MPC-PI controller, and a curve 1316 illustrates the response of the MPC-(1+PIDN) controller. The curves demonstrate how each controller manages power-sharing in response to load changes, with the MPC-(1+PIDN) controller (plot 1316) showcasing effective power-sharing as evidenced by the smaller amplitude of fluctuations.

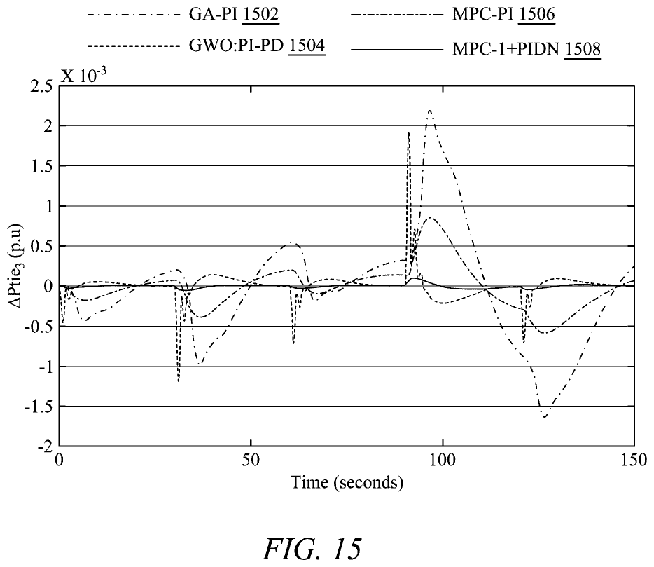

FIG. 14 presents a graphical analysis of the tie-line 23 power-sharing response of the various controllers implemented within the second power system, where each plot is associated with a specific control strategy.

FIG. 14 displays a response of the GA-PI controller illustrated as a curve 1412, a response of GWO-PI-PD controller as a curve 1414, response of the MPC-PI controller as a curve 1418, and a response of the MPC-(1+PIDN) controller as plot 1416. The MPC-(1+PIDN) controller maintains power-sharing close to the nominal range, indicating effective frequency stabilization.

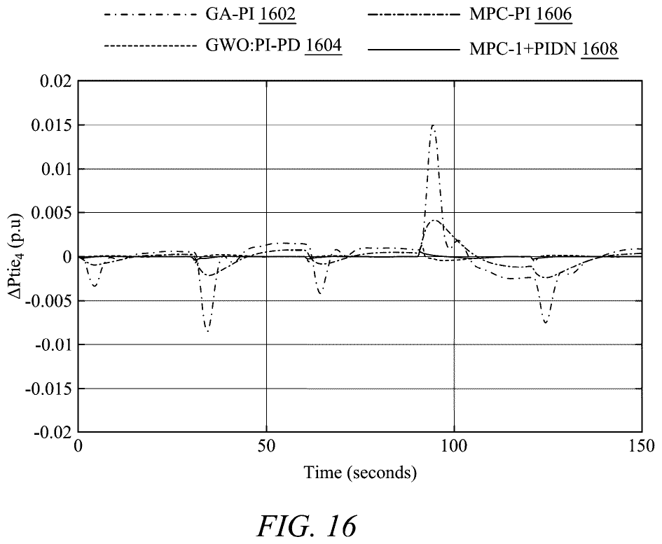

FIG. 15 illustrates the tie-line 13 power-sharing response of the various controllers implemented within the third power system. The frequency deviations are depicted for the GA-PI controller, by curve 1512, the GWO-PI-PD controller, by curve plot 1514, the MPC-PI controller, by a curve 1518, and the MPC-(1+PIDN) controller, by a curve 1516. The MPC-(1+PIDN) controller shows a more stable response with fewer oscillations and quicker stabilization, emphasizing its robustness.

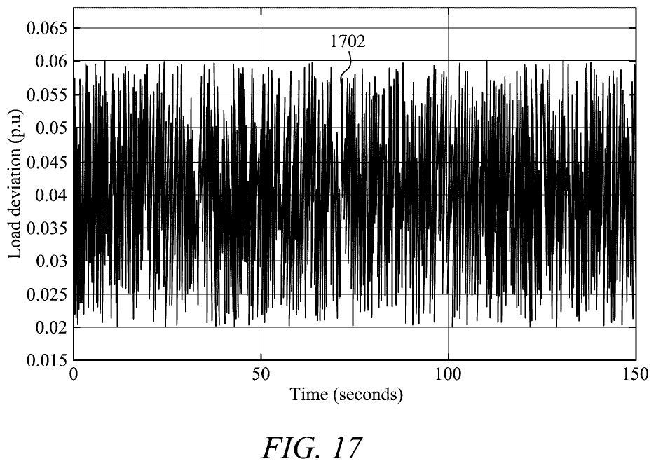

FIG. 16 illustrates the tie-line 14 power-sharing response of the various controllers implemented within the fourth power system. In this illustration, the responses are depicted for the GA-PI controller, by a curve 1612, the GWO-PI-PD controller, by a curve 1614, the MPC-PI controller, by a curve 1618, and the MPC-(1+PIDN) controller, by a curve 1616. The response curve 1616 of the MPC-(1+PIDN) controller, reflects a proficient power-sharing capability, with quick damping of fluctuations and minimal overshoot and undershoot.

The response time (ST) of the MPC-(1+PIDN) controller is 0.86 s and has an undershoot response (US) of −0.001 for the first geographic area. In comparison, the response of GWO: PI-PD controller is 3.3 s while also exhibiting US and an overshoot (OS) of −0.03 and 0.01 respectively in the first geographic area. Similarly, the response of MPC/PI presents a settling time (ST) of 9.57 seconds and a US response of −0.03 with no OS. For the first geographic area, the response manifested by GA-PI is 17.87 seconds to settle the frequency fluctuation, while US and OS are −0.18 and 0.01, respectively. In the case of the second geographic area, the controller shows an ST of 1.08 s and OS of 0.01 with no US. In comparison, the ST, US and OS of GWO: PI-Pd are 2.93 seconds, 0 and 0.05, respectively. In the case of the MPC/PI controller, the ST is 9.57 seconds, US is −0.03 with no OS. The GA-PI controller shows ST of 20.1 seconds and the responses of US and OS are −0.01 and 0.18, respectively. The simulated response of the MPC-(1+PIDN) in the third geographic area shows an ST of 0.81 seconds, US of −0.01 with no OS. Similarly, in third geographic area, the ST responses of GWO: PI-PD, MPC/PI and GA-PI are 4.45 seconds, 9.76 seconds and 17.93 seconds, respectively. The US of the GWO: PI-PD, MPC/PI and GA-PI are −0.04, −0.02 and −0.18, respectively. Further, the OS response of GWO: PI-PD is 0.01, while the MPC/PI presents no OS and GA-PI exhibits 0.01 OS response.

The responses of the MPC-(1+PIDN), GWO: PI-PD, MPC/PI and GA-PI in the fourth geographic area show STs of 0.84 seconds, 3.26 seconds, 13.5 seconds and 18 seconds, while the US are 0, −0.02, −0.006 and −0.12, respectively. In case of the OS responses, the MPC-(1+PIDN), GWO: PI-PD, MPC/PI and GA-PI depict 0.02, 0.06, 0.05, and 0.24, respectively.

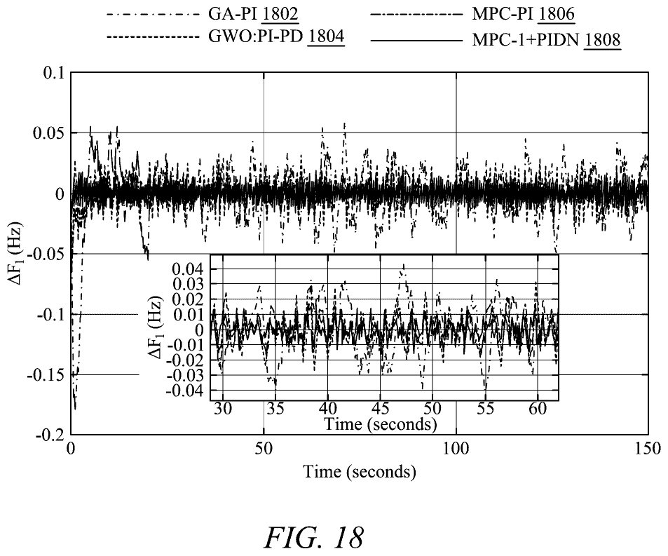

FIG. 17 illustrates the load deviation response of a controller over time for a system subjected to random load variations. Curve 1702 indicates a response of the MPC-(1+PIDN) controller 508 to a random changing load between 1% to 6% variations.

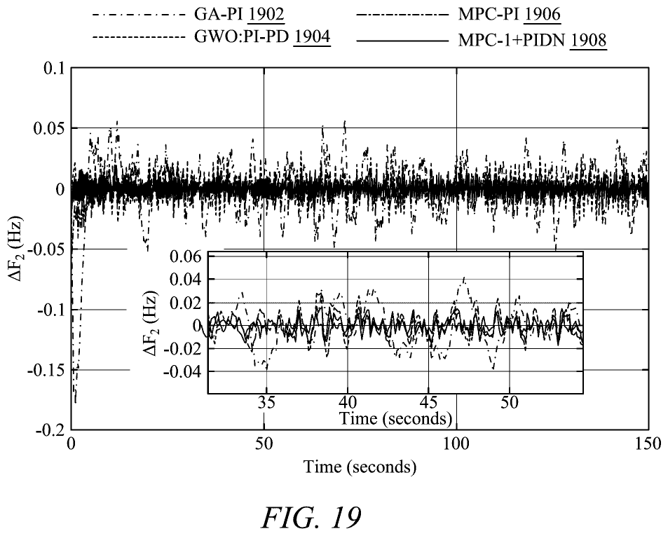

FIG. 18 illustrates the frequency response of the first power system implemented for the first geographic area. Various curves compare the efficacy of several control strategies over time. Curve 1802 depicts the GA-PI controller response, curve 1804 shows the response of the GWO: PI-PD controller, and curve 1806 outlines the MPC-PI controller response. The MPC-(1+PIDN) controller response is presented by curve 1808. Curve 1808 demonstrates the robustness of the MPC-(1+PIDN) controller that suppresses the frequency fluctuation in minimum time compared to other controllers.

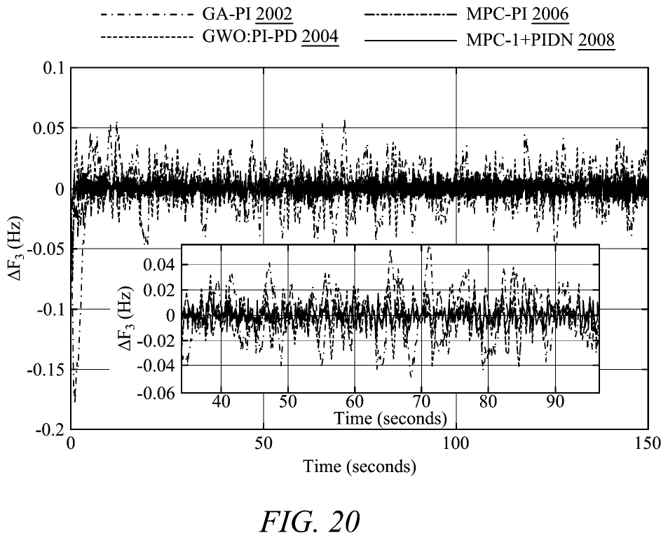

FIG. 19 illustrates the frequency response of the second power system implemented for the second geographic area. Various curves compare the efficacy of several control strategies over time. Curve 1902 depicts the GA-PI controller response, curve 1904 shows the response of the GWO: PI-PD controller, and curve 1906 illustrates the MPC-PI controller response. The MPC-(1+PIDN) controller response is presented by curve 1908. Curve 1908 demonstrates the robustness of the MPC-(1+PIDN) controller that suppresses the frequency fluctuation in minimum time compared to other controllers.

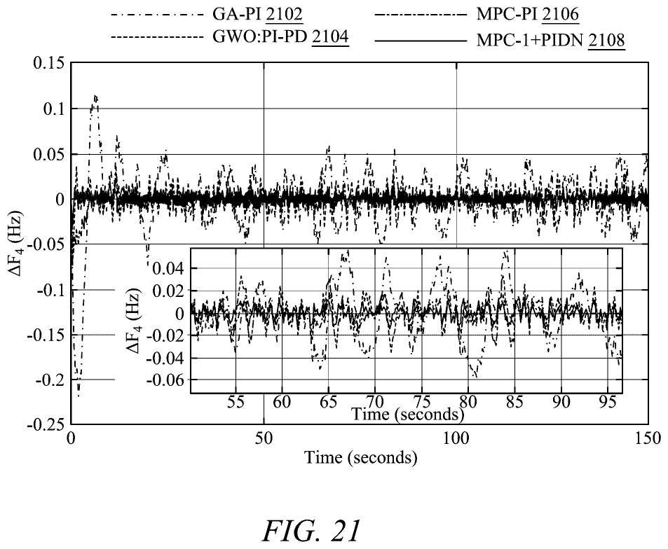

FIG. 20 illustrates the frequency response of the third power system implemented for the third geographic area. Various curves compare the efficacy of several control strategies over time. Curve 2002 depicts the GA-PI controller response, curve 2004 shows the response of the GWO: PI-PD controller, and curve 2006 illustrates the MPC-PI controller response. The MPC-(1+PIDN) controller response is presented by curve 2008. Curve 2008 demonstrates the robustness of the MPC-(1+PIDN) controller that suppresses the frequency fluctuation in minimum time compared to other controllers.

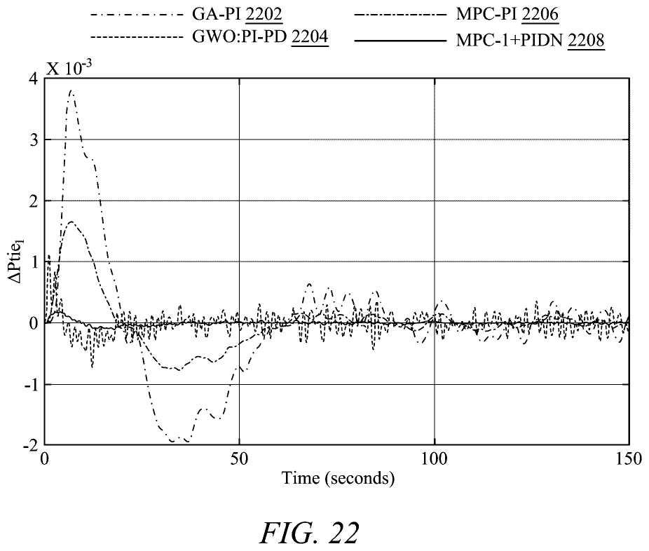

FIG. 21 illustrates the frequency response of the fourth power system implemented for the fourth geographic area. Various curves compare the efficacy of several control strategies over time. Curve 2102 depicts the GA-PI controller response, curve 2104 shows the response of the GWO: PI-PD controller, and curve 2106 illustrates the MPC-PI controller response. The MPC-(1+PIDN) controller response is presented by curve 2108. Curve 2108 demonstrates the robustness of the MPC-(1+PIDN) controller that suppresses the frequency fluctuation in minimum time compared to other controllers.

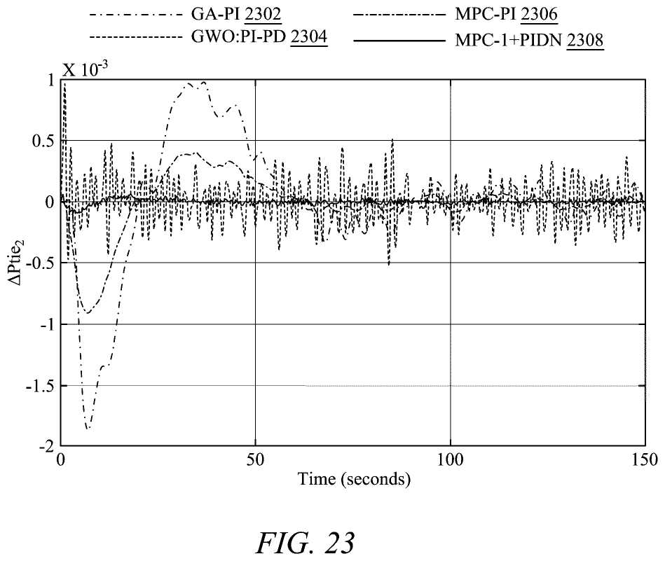

FIG. 22 illustrates an electrical tie-line 12 response between the first geographic area and the second geographic area. Connectivity between the first power system and the second power system is achieved through the electrical tie-line 12. Various curves shows response by various controllers to sharing of power between two geographic areas through the tie-line. Curve 2202 depicts the GA-PI controller response, curve 2204 shows the response of the GWO: PI-PD controller, and curve 2206 illustrates the MPC-PI controller response. The MPC-(1+PIDN) controller response is presented by curve 2208. Curve 2208 demonstrates the most efficient sharing of power between the corresponding geographic areas.

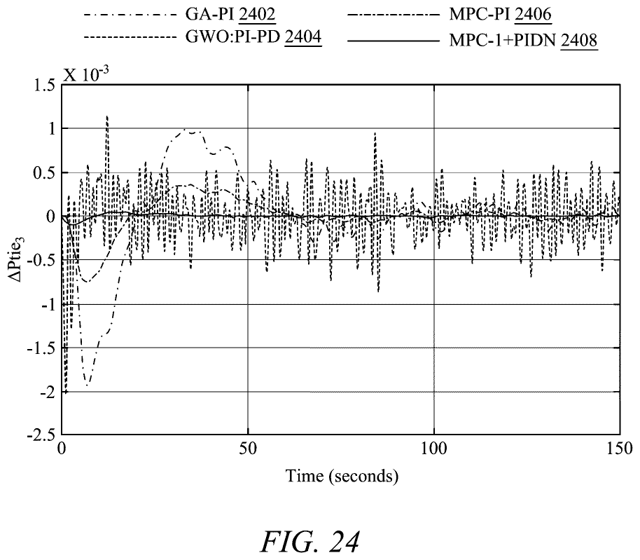

FIG. 23 illustrates an electrical tie-line 13 response between the first geographic area and the third geographic area. Connectivity between the first power system and the third power system is achieved through the electrical tie-line 13. Various curves shows response by various controllers to sharing of power between two geographic areas through the tie-line. Curve 2302 depicts the GA-PI controller response, curve 2304 shows the response of the GWO: PI-PD controller, and curve 2306 illustrates the MPC-PI controller response. The MPC-(1+PIDN) controller response is presented by curve 2308. Curve 2308 demonstrates the most efficient sharing of power between the corresponding geographic areas.

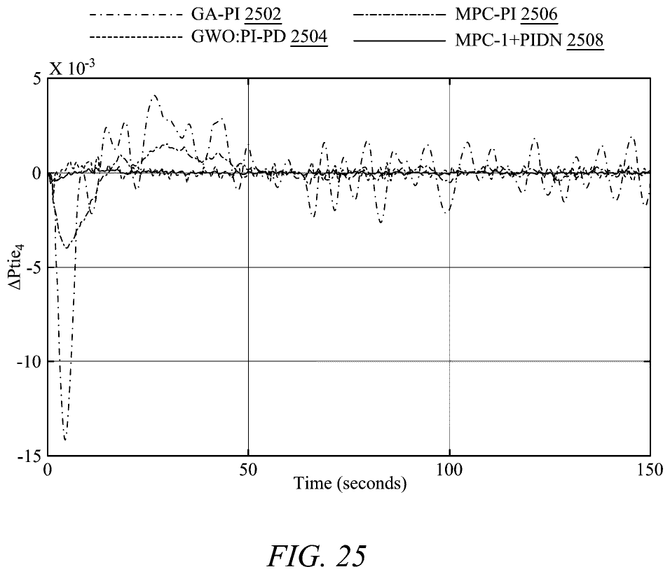

FIG. 24 illustrates a tie-line 23 response between the second geographic area and the third geographic area. Connectivity between the second power system and the third power system is achieved through the tie-line 23. Various curves shows response by various controllers to sharing of power between two geographic areas through the tie-line. Curve 2402 depicts the GA-PI controller response, curve 2404 shows the response of the GWO: PI-PD controller, and curve 2406 illustrates the MPC-PI controller response. The MPC-(1+PIDN) controller response is presented by curve 2408. Curve 2408 demonstrates the most efficient sharing of power between the corresponding geographic areas.

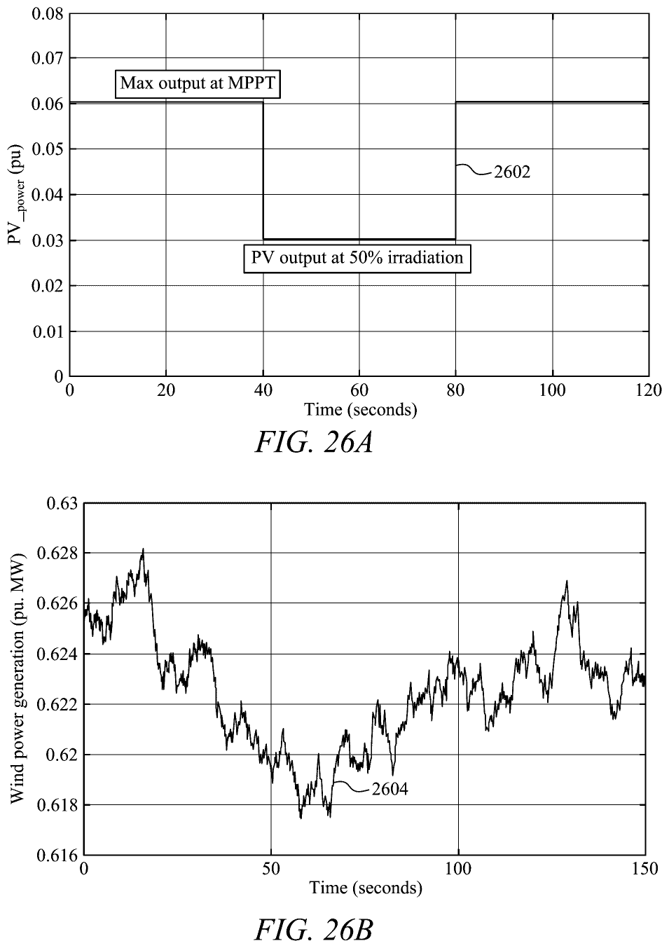

FIG. 25 illustrates an electrical tie-line 14 response between the first geographic area and the fourth geographic area. Connectivity between the first power system and the fourth power system is achieved through the tie-line 14. Various curves shows response by various controllers to sharing of power between two geographic areas through the tie-line. Curve 2502 depicts the GA-PI controller response, curve 2504 shows the response of the GWO: PI-PD controller, and curve 2506 illustrates the MPC-PI controller response. The MPC-(1+PIDN) controller response is presented by curve 2508. Curve 2508 demonstrates the most efficient sharing of power between the corresponding geographic areas.

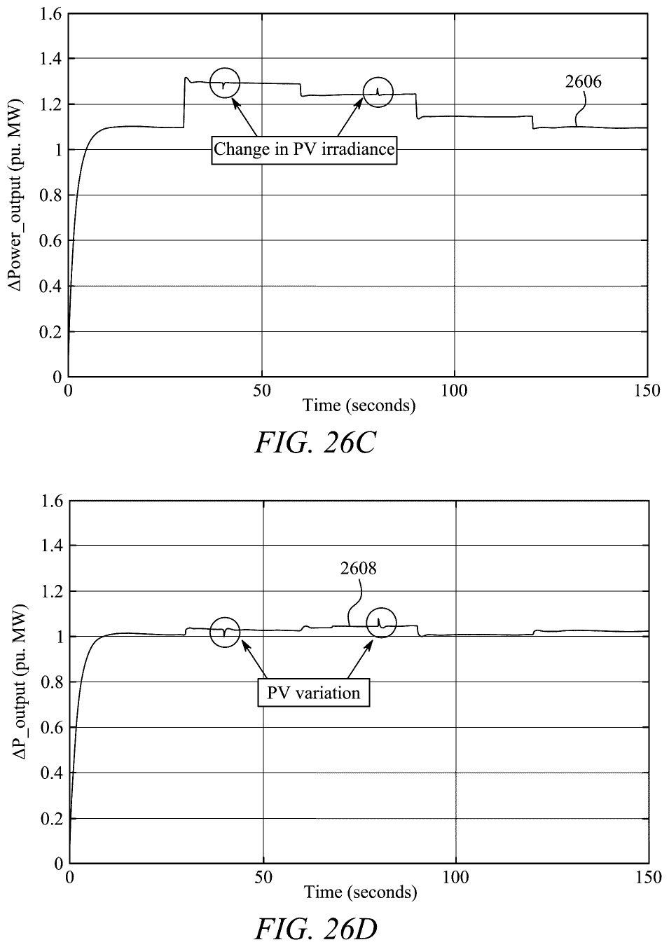

FIG. 26A-FIG. 26D illustrate the collective output power response from various energy sources integrated into the grid.

In FIG. 26A, curve 2602 displays the output power of a photovoltaic (PV) source versus time in seconds. Curve 2602 indicates the maximum power attainable at Maximum Power Point Tracking (MPPT) and the corresponding output at 50% irradiation. The time in seconds is plotted on the x-axis, and the power in per unit (p.u.) is plotted on the y-axis, illustrating the variation in power output with changing solar irradiance.

In FIG. 26B, curve 2604 shows the wind power generation (in pu.MW) versus time in seconds. The power output is marked by its variability, which is characteristic of wind energy due to fluctuating wind speeds.

In FIG. 26C, curve 2606 combines the total output power from thermal energy with PV and wind power contributions versus time in seconds. The curve 2606 illustrates reaction of the overall power output to a change in PV irradiance over the course of time, indicating the combined influence of renewable and conventional energy sources on total power output.

In FIG. 26D, curve 2608 presents the total output power when hydropower is included with PV and wind versus time in seconds. The graph illustrates the variations in power output, particularly highlighting the impact of PV irradiance changes on the combined energy output.

The present disclosure presents a control approach for a high-order interconnected area (HOIA), where the complexity of a power system was elevated by integrating renewable energy sources (RES) into the power system. Introducing a hydropower plant in the fourth geographic area introduces a right-half-plane zero into the open-loop system, complicating control efforts. To manage such complex network effectively, a robust control system was necessary to counteract frequency deviations resulting from load imbalances. A layered control architecture that combines a MPC with a 1+PIDN controller is demonstrated in the present disclosure. The MPC-(1+PIDN) configuration addresses the demands of the HOIA system, normalizing frequency variations caused by load imbalances in under and about 0.86 seconds, in contrast to the slower responses of other controllers, such as the GWO: PI-PD controller at about 3.3 seconds, the MPC/PI controller at about 9.57 seconds, and the GA-PI controller at about 17.87 seconds. Performance of the controller was evaluated under a variety of load-change scenarios, demonstrating its efficacy when compared to other advanced controllers.

In a first embodiment, a load frequency control system for a multi-region power system incorporating a plurality of renewable energy sources, comprising a first power system located in a first geographic region (area-1), a second power system located in a second geographic region (area-2), a third power system located a third geographic region (area-3), a fourth power system located in a fourth geographic region (area-4), a first electrical tie-line configured to connect the first power system with the second power system, a second electrical tie-line configured to connect the first power system with the third power system, a third electrical tie-line configured to connect the second power system with the third power system, a fourth electrical tie-line configured to connect the first power system with the fourth power system, where each power system is configured to generate area control signals (ACE), a MPC operatively connected to receive the ACE signals from each electrical tie-line, where the MPC includes a memory storing program instructions, and at least one processor configured to execute the program instructions to generate a control signal u(k), a one plus proportional integral derivative (1+PIDN) controller operatively connected to the MPC, wherein the 1+PIDN controller includes a set of amplifiers having gain parameters, and an optimizer operatively connected to the MPC, wherein the optimizer is configured to receive the ACE signals, apply the ACE signals to a salp swarm algorithm and update the gain parameters of the 1+PIDN controller, where the 1+PIDN controller is configured to receive the control signal u(k) and the updated gain parameters and generate an output signal configured to mitigate power disturbances due to frequency disturbances on the first electrical tie line, the second electrical tie-line, the third electrical tie-line and the fourth electrical tie-line.

In one aspect, the load frequency control system further comprises a first thermal generator, a first photovoltaic energy generator, a first wind energy generator and a first load located in the first power system, a second thermal generator, a second photovoltaic energy generator, a second wind energy generator and a second load located in the second power system, a third thermal generator, a third photovoltaic energy generator, a third wind energy generator and a third load located in the third power system, and a hydropower plant configured to generate electricity from flowing water, a fourth photovoltaic energy generator, a fourth wind energy generator and a fourth load located in the fourth power system.

In one aspect, each thermal generator includes a governor, an electrical generator, a steam turbine, and a reheater.

In one aspect, the controller gain parameters include a gain of one, a proportional gain Kₚ, an integral gain Kᵢ, and a derivative gain K_{D} and a filter factor N.

In one aspect, the output signal is based on the equation:

$$output = ( 1 + {K}_{P} + \frac{{K}_{I}}{s} + \frac{{K}_{D} Ns}{N + s} ) \times u ( k ) .$$

In one aspect, the program instructions include a cost function J_{ITAE}, where the optimizer is configured to receive the cost function J_{ITAE} and minimize the cost function J_{ITAE} to update the gain parameters.

In one aspect, the cost function J_{ITAE} is an integral time absolute error given by:

$${J}_{ITAE} = {\int }_{0}^{{T}_{Sin}} t ( \vert {ACE}_{1} ( t ) \vert + \vert {ACE}_{2} ( t ) \vert + \vert {ACE}_{3} ( t ) \vert + \vert {ACE}_{4} ( t ) \vert ) dt$$

where t is time, ACE₁ is the ACE signal generated by the first power system, ACE₂ is the ACE signal generated by the second power system, ACE₃ is the ACE signal generated by the third power system, ACE₄ is the ACE signal generated by the fourth power system.

In one aspect, each power system includes a busbar and a load connected to the busbar, where the busbar is connected one or more of electrical tie-lines, and where the power disturbances are due to changes in a demand of the load located in the respective power system.

In one aspect, the first power system comprises a first busbar connected to receive the power disturbances from each of the first tie-line, the second tie-line and the fourth tie-line, a frequency meter configured to measure a frequency on each of the first tie-line, the second tie-line and the fourth tie-line and generate a combined frequency measurement, a first subtractor configured to subtract the combined frequency measurement from a reference frequency and generate a power to frequency ratio bias signal, an interchange scheduler configured to generate a time window for an exchange of power from the first busbar to the MPC, a second subtractor configured to receive the power disturbances from the first busbar and transmit the power disturbances during the scheduled time window, and a third subtractor configured to subtract the power to frequency ratio bias signal from the scheduled power disturbances and generate the ACE₁ signal.

In one aspect, the second power system comprises a second busbar connected to receive the power disturbances from each of the first tie-line and the third tie-line, a frequency meter located in the second power system, where the frequency meter is configured to measure a frequency on each of the first tie-line and the third tie-line and generate a combined frequency measurement, a first subtractor configured to subtract the combined frequency measurement from a reference frequency and generate a power to frequency ratio bias signal, an interchange scheduler configured to generate a time window for an exchange of power from the second busbar to the MPC, a second subtractor configured to receive the power disturbances from the second busbar and transmit the power disturbances during the scheduled time window, and a third subtractor configured to subtract the power to frequency ratio bias signal from the scheduled power disturbances and generate the ACE₂ signal.

In one aspect, the third power system comprises a third busbar connected to receive the power disturbances from each of the second tie-line and the third tie-line, a frequency meter located in the second power system, wherein the frequency meter is configured to measure a frequency on each of the second tie-line and the third tie-line and generate a combined frequency measurement, a first subtractor configured to subtract the combined frequency measurement from a reference frequency and generate a power to frequency ratio bias signal, an interchange scheduler configured to generate a time for an exchange of power from the third busbar to the MPC, a second subtractor configured to receive the power disturbances from the third busbar and transmit the power disturbances at the scheduled time, and a third subtractor configured to subtract the power to frequency ratio bias signal from the scheduled power disturbances and generate the ACE₃ signal.

In one aspect, the fourth power system comprises a fourth busbar connected to receive the power disturbances from the fourth tie-line, a frequency meter located in the second power system, wherein the frequency meter is configured to measure a frequency on the fourth tie-line and generate a frequency measurement, a first subtractor configured to subtract the frequency measurement from a reference frequency and generate a power to frequency ratio bias signal, an interchange scheduler configured to generate a time window for an exchange of power from the fourth busbar to the MPC, a second subtractor configured to receive the power disturbances from the fourth busbar and transmit the power disturbances during the scheduled time window, and a third subtractor configured to subtract the power to frequency ratio bias signal from the scheduled power disturbances and generate the ACE₃ signal.

In a second embodiment, a method for load frequency control of a multi-region power system incorporating a plurality of renewable energy sources comprises connecting a first power system located in a first geographic region to a second power system located in a second geographic region by a first electrical tie-line, connecting the first power system to a third power system located in a third geographic region by a second electrical tie-line, connecting the second power system to the third power system by a third electrical tie-line, connecting the first power system to a fourth power system located in a fourth geographic region by a fourth electrical tie-line, generating, by each power system, area control signals (ACE), receiving, by a model predictive controller (MPC) including a memory storing program instructions and at least one processor configured to execute the program instructions, the ACE signals from each power system, generating, by the MPC, a control signal u(k), connecting a one plus proportional integral derivative (1+PIDN) controller which includes a set of amplifiers having gain parameters to the MPC, connecting an optimizer to the MPC receiving, by the optimizer, the ACE signals, applying, by the optimizer, the ACE signals to a salp swarm algorithm, updating, by the optimizer, the gain parameters, receiving, by the 1+PIDN controller, the control signal u(k) and the updated gain parameters, and generating, by the 1+PIDN controller, an output signal configured to mitigate power disturbances due to frequency imbalances on the first electrical tie line, the second electrical tie-line, the third electrical tie-line and the fourth electrical tie-line.

In one aspect, the method further comprises calculating, by the 1+PIDN controller, the output signal based on the equation:

$$output = ( 1 + {K}_{P} + \frac{{K}_{I}}{s} + \frac{{K}_{D} Ns}{N + s} ) \times u ( k ) ,$$

where Kₚ is a proportional gain, Kᵢ is an integral gain, K_{D} is a derivative gain and N is a filter factor.

In one aspect, the method further comprises fetching, by the optimizer, a cost function J_{ITAE} from the program instructions, where the cost function J_{ITAE} is an integral time absolute error given by:

$${J}_{ITAE} = {\int }_{0}^{{T}_{Sim}} t ( \vert {ACE}_{1} ( t ) \vert + \vert {ACE}_{2} ( t ) \vert + \vert {ACE}_{3} ( t ) \vert + \vert {ACE}_{4} ( t ) \vert ) dt$$

where t is time, ACE₁ is the ACE signal generated by the first power system, ACE₂ is the ACE signal generated by the second power system, ACE₃ is the ACE signal generated by the third power system, ACE₄ is the ACE signal generated by the fourth power system, minimizing, by the optimizer, the cost function J_{ITAE}, and updating each of the gain parameters based on minimizing the cost function J_{ITAE}.

In an aspect, the method further comprising connecting a load to a busbar in each power system, connecting the busbar to one or more of the electrical tie-lines, measuring, by a frequency meter, a frequency imbalance on each of the one or more of the electrical tie-lines due to changes in a demand of the load located in the respective power system, generating, by the frequency meter, a combined frequency imbalance measurement, subtracting, by a first subtractor, the combined frequency imbalance measurement from a reference frequency and generating a power to frequency ratio bias signa, receiving, by the busbar, a combined power disturbance signal on the electrical tie-lines connected to the busbar, generating, by an interchange scheduler, a scheduled time window for an exchange of the combined power disturbance signal to the MPC, receiving, by a second subtractor, the combined power disturbance signal and the scheduled time window, transmitting, by the second subtractor, the combined power disturbance signal at the scheduled time window, receiving, by a third subtractor, the combined power disturbance signal at the scheduled time window and the power to frequency ratio bias signal, subtracting, by a third subtractor, the combined power disturbance signal from the power to frequency ratio bias signal, generating, by the third subtractor, the ACE signal of the respective power system, and transmitting, by the third subtractor, the ACE signal of the respective power system to the MPC.

In one aspect, the method further comprising connecting, in the first power system, a first thermal generator, a first photovoltaic energy generator, a first wind energy generator and a first load to a first busbar, connecting, in the second power system, a second thermal generator, a second photovoltaic energy generator, a second wind energy generator and a second load to a second busbar, connecting, in the third power system, a third thermal generator, a third photovoltaic energy generator, a third wind energy generator and a third load to a third busbar, and connecting, in the fourth power system, a hydropower plant configured to generate electricity from flowing water, a fourth photovoltaic energy generator, a fourth wind energy generator and a fourth load to a fourth busbar.

In a third embodiment, a hybrid load frequency controller for interconnected multi-region power systems incorporating a plurality of renewable energy sources, comprising a MPC operatively connected to receive area control error (ACE) signals from electrical tie-lines which interconnect the multi-region power systems, where the MPC includes a memory storing program instructions, and at least one processor configured to execute the program instructions to generate a control signal u(k), a one plus proportional integral derivative (1+PIDN) controller operatively connected to the MPC, where the 1+PIDN controller includes a set of amplifiers having gain parameters, and an optimizer operatively connected to the MPC, where the optimizer is configured to receive the ACE signals, apply the ACE signals to a salp swarm algorithm and update the gain parameters of the 1+PIDN controller, where the 1+PIDN controller is configured to receive the control signal u(k) and the updated gain parameters and generate an output signal configured to mitigate power disturbances due to frequency imbalances on the electrical tie-lines which interconnect the multi-region power systems.

In one aspect, the hybrid load frequency controller further comprising a cost function J_{ITAE} stored within the program instructions, where the optimizer is configured to fetch the cost function J_{ITAE}, apply the cost function J_{ITAE} to the salp swarm algorithm, and execute the salp swarm algorithm to minimize the cost function J_{ITAE}.

In one aspect, the cost function J_{ITAE} is an integral time absolute error given by:

$${J}_{ITAE} = {\int }_{0}^{{T}_{Sim}} t ( \vert {ACE}_{1} ( t ) \vert + \vert {ACE}_{2} ( t ) \vert + \vert {ACE}_{3} ( t ) \vert + \vert {ACE}_{4} ( t ) \vert ) dt$$

where t is time, ACE₁ is an ACE signal generated by a first power system of the interconnected multi-region power systems, ACE₂ is an ACE signal generated by a second power system of the interconnected multi-region power systems, ACE₃ is an ACE signal generated by a third power system of the interconnected multi-region power systems, and ACE₄ is an ACE signal generated by a fourth power system of the interconnected multi-region power systems.

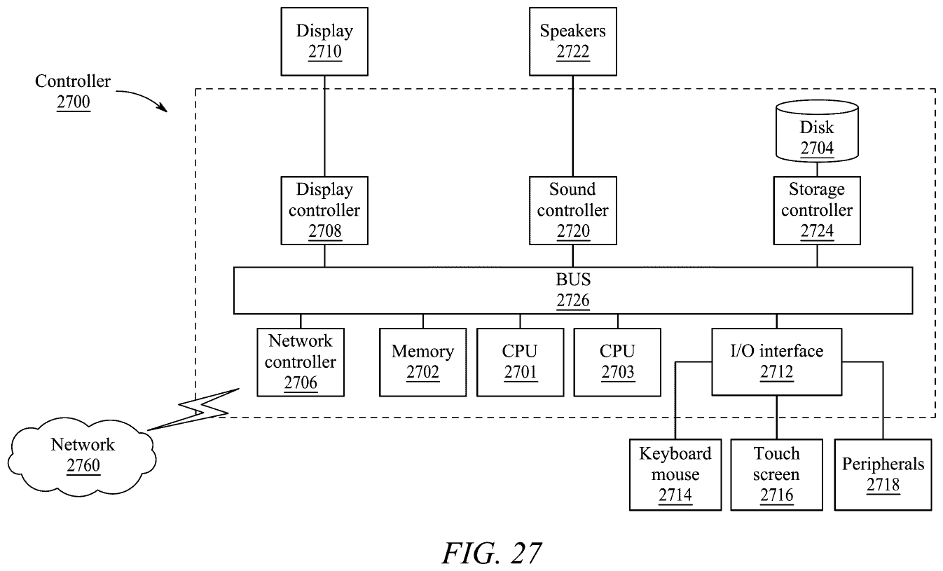

Next, further details of the hardware description of the computing environment according to exemplary embodiments are described with reference to FIG. 27. In FIG. 27, a controller 2700 is described is representative of the MPC-(1+PIDN) controller 508 of FIG. 5B of the system in which the controller is a computing device which includes a CPU 2701 which performs the processes described above/below. The process data and instructions may be stored in memory 2702. These processes and instructions may also be stored on a storage medium disk 2704 such as a hard drive (HDD) or portable storage medium or may be stored remotely.

Further, the claims are not limited by the form of the computer-readable media on which the instructions of the inventive process are stored. In an example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 2701, 2703 and an operating system such as Microsoft Windows 7, Microsoft Windows 10, Microsoft Windows 11, UNIX, Solaris, LINUX, Apple MAC-OS and other systems known to those skilled in the art.

The hardware elements in order to achieve the computing device may be realized by various circuitry elements, known to those skilled in the art. In an example, CPU 2701 or CPU 2703 may be a Xenon or Core processor from Intel of America or an Opteron processor from AMD of America, or may be other processor types that would be recognized by one of ordinary skill in the art. Alternatively, the CPU 2701, 2703 may be implemented on an FPGA, ASIC, PLD or using discrete logic circuits, as one of ordinary skill in the art would recognize. Further, CPU 2701, 2703 may be implemented as multiple processors cooperatively working in parallel to perform the instructions of the inventive processes described above.

The computing device in FIG. 27 also includes a network controller 2706, such as an Intel Ethernet PRO network interface card from Intel Corporation of America, for interfacing with network 2760. As can be appreciated, the network 2760 can be a public network, such as the Internet, or a private network such as an LAN or WAN network, or any combination thereof and can also include PSTN or ISDN sub-networks. The network 2760 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 2708, such as a NVIDIA GeForce GTX or Quadro graphics adaptor from NVIDIA Corporation of America for interfacing with display 2710, such as a Hewlett Packard HPL2445w LCD monitor. A general purpose I/O interface 2712 interfaces with a keyboard and/or mouse 2714 as well as a touch screen panel 2716 on or separate from display 2710. General purpose I/O interface also connects to a variety of peripherals 2718 including printers and scanners, such as an OfficeJet or DeskJet from Hewlett Packard.

A sound controller 2720 is also provided in the computing device such as Sound Blaster X-Fi Titanium from Creative, to interface with speakers/microphone 2722 thereby providing sounds and/or music.

The general purpose storage controller 2724 connects the storage medium disk 2704 with communication bus 2726, which may be an ISA, EISA, VESA, PCI, or similar, for interconnecting all of the components of the computing device. A description of the general features and functionality of the display 2710, keyboard and/or mouse 2714, as well as the display controller 2708, storage controller 2724, network controller 2706, sound controller 2720, and general purpose I/O interface 2712 is omitted herein for brevity as these features are known.

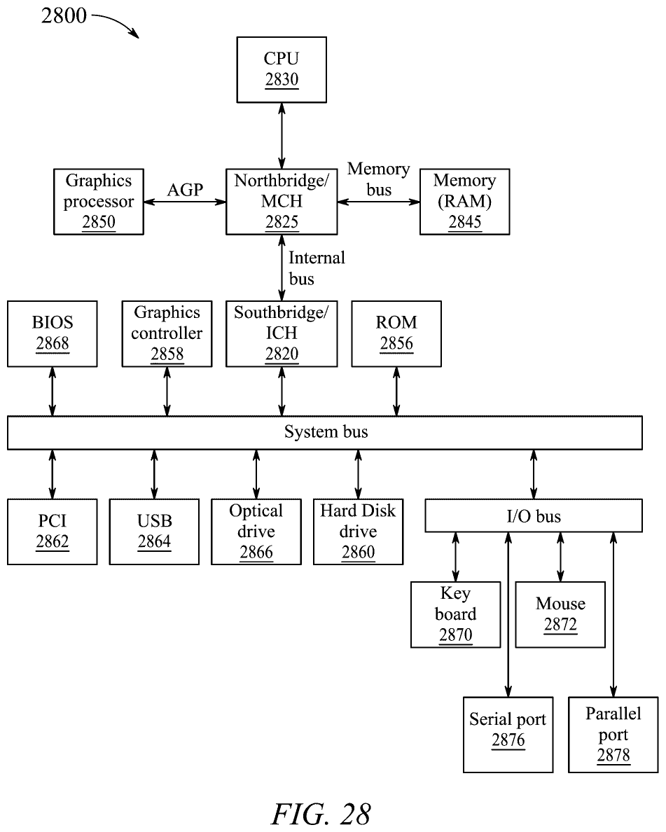

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 28.

FIG. 28 shows a schematic diagram of a data processing system, according to certain embodiments, for performing the functions of the exemplary embodiments. The data processing system is an example of a computer in which code or instructions implementing the processes of the illustrative embodiments may be located.

In FIG. 28, data processing system 2800 employs a hub architecture including a north bridge and memory controller hub (NB/MCH) 2825 and a south bridge and input/output (I/O) controller hub (SB/ICH) 2820. The central processing unit (CPU) 2830 is connected to NB/MCH 2825. The NB/MCH 2825 also connects to the memory 2845 via a memory bus, and connects to the graphics processor 2850 via an accelerated graphics port (AGP). The NB/MCH 2825 also connects to the SB/ICH 2820 via an internal bus (e.g., a unified media interface or a direct media interface). The CPU Processing unit 2830 may contain one or more processors and even may be implemented using one or more heterogeneous processor systems.

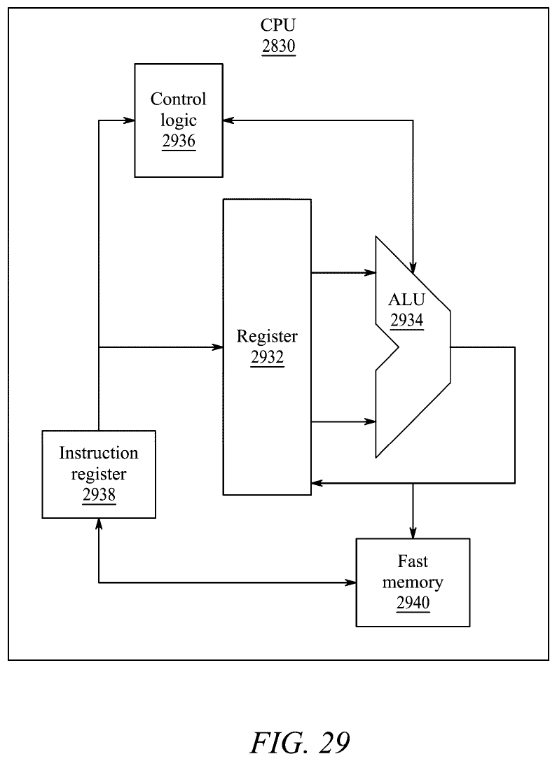

In an example, FIG. 29 shows one implementation of CPU 2830. In one implementation, the instruction register 2938 retrieves instructions from the fast memory 2940. At least part of these instructions are fetched from the instruction register 2938 by the control logic 2936 and interpreted according to the instruction set architecture of the CPU 2830. Part of the instructions can also be directed to the register 2932. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 2934 that loads values from the register 2932 and performs logical and mathematical operations on the loaded values according to the instructions. The results from these operations can be feedback into the register and/or stored in the fast memory 2940. According to certain implementations, the instruction set architecture of the CPU 2830 can use a reduced instruction set architecture, a complex instruction set architecture, a vector processor architecture, a very large instruction word architecture. Furthermore, the CPU 2830 can be based on the Von Neuman model or the Harvard model. The CPU 2830 can be a digital signal processor, an FPGA, an ASIC, a PLA, a PLD, or a CPLD. Further, the CPU 2830 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 28, the data processing system 2800 can include that the SB/ICH 2820 is coupled through a system bus to an I/O Bus, a read only memory (ROM) 2856, universal serial bus (USB) port 2864, a flash binary input/output system (BIOS) 2868, and a graphics controller 2858. PCI/PCIe devices can also be coupled to SB/ICH 2888 through a PCI bus 2862.

The PCI devices may include, for example, Ethernet adapters, add-in cards, and PC cards for notebook computers. The Hard disk drive 2860 and CD-ROM 2866 can use, for example, an integrated drive electronics (IDE) or serial advanced technology attachment (SATA) interface. In one implementation the I/O bus can include a super I/O (SIO) device.

Further, the hard disk drive (HDD) 2860 and optical drive 2866 can also be coupled to the SB/ICH 2820 through a system bus. In one implementation, a keyboard 2870, a mouse 2872, a parallel port 2878, and a serial port 2876 can be connected to the system bus through the I/O bus. Other peripherals and devices that can be connected to the SB/ICH 2820 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. In an example, the skilled artisan will appreciate that the circuitry described herein may be adapted based on changes on battery sizing and chemistry, or based on the requirements of the intended back-up load to be powered.

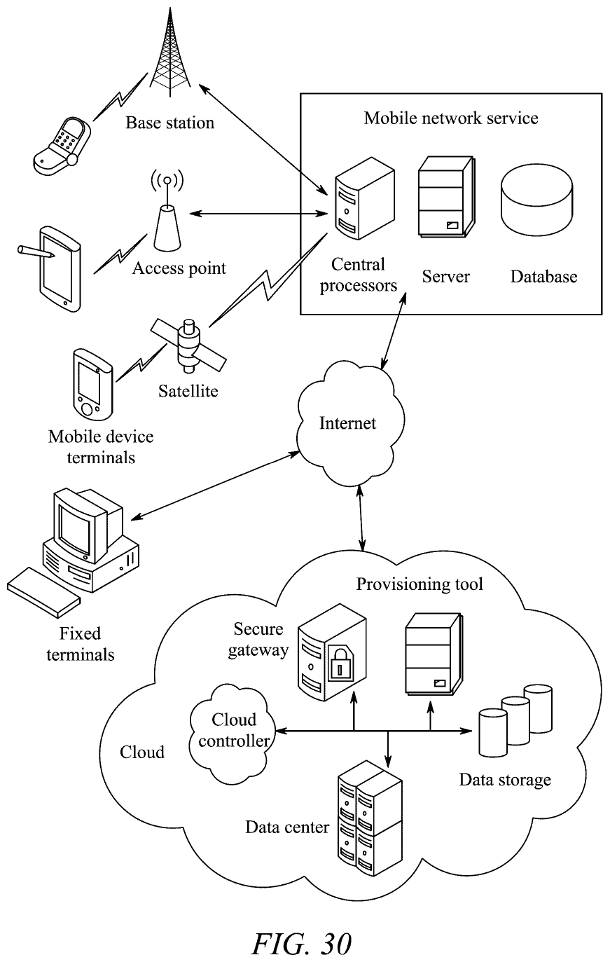

The functions and features described herein may also be executed by various distributed components of a system. In an example, one or more processors may execute these system functions, wherein the processors are distributed across multiple components communicating in a network. The distributed components may include one or more client and server machines, which may share processing, as shown by FIG. 30, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A load frequency control system for a multi-region power system incorporating a plurality of renewable energy sources, comprising:
a first power system located in a first geographic region;
a second power system located in a second geographic region;
a third power system located in a third geographic region;
a fourth power system located in a fourth geographic region;
a first electrical tie-line configured to connect the first power system with the second power system;
a second electrical tie-line configured to connect the first power system with the third power system;
a third electrical tie-line configured to connect the second power system with the third power system;
a fourth electrical tie-line configured to connect the first power system with the fourth power system,
wherein each power system is configured to generate area control signals (ACE);
a model predictive controller (MPC) operatively connected to receive the ACE signals from each electrical tie-line, wherein the MPC includes a memory storing program instructions, and at least one processor configured to execute the program instructions to generate a control signal u(k);
a one plus proportional integral derivative (1+PIDN) controller operatively connected to the MPC, wherein the 1+PIDN controller includes a set of amplifiers having gain parameters; and
an optimizer operatively connected to the MPC, wherein the optimizer is configured to receive the ACE signals, apply the ACE signals to a salp swarm algorithm and update the gain parameters of the 1+PIDN controller,
wherein the 1+PIDN controller is configured to receive the control signal u(k) and the updated gain parameters and generate an output signal configured to mitigate power disturbances due to frequency disturbances on the first electrical tie line, the second electrical tie-line, the third electrical tie-line and the fourth electrical tie-line.

2. The load frequency control system of claim 1, further comprising:
a first thermal generator, a first photovoltaic energy generator, a first wind energy generator and a first load located in the first power system;
a second thermal generator, a second photovoltaic energy generator, a second wind energy generator and a second load located in the second power system;
a third thermal generator, a third photovoltaic energy generator, a third wind energy generator and a third load located in the third power system; and
a hydropower plant configured to generate electricity from flowing water, a fourth photovoltaic energy generator, a fourth wind energy generator and a fourth load located in the fourth power system.

3. The load frequency control system of claim 2, wherein each thermal generator includes a governor, an electrical generator, a steam turbine and a reheater.

4. The load frequency control system of claim 1, wherein the controller gain parameters include a gain of one, a proportional gain Kₚ, an integral gain Kᵢ, and a derivative gain K_{D} and a filter factor N.

5. The load frequency control system of claim 4, wherein the output signal is based on the equation:
$$output = ( 1 + {K}_{P} + \frac{{K}_{I}}{s} + \frac{{K}_{D} Ns}{N + s} ) \times u ( k ) .$$

6. The load frequency control system of claim 4, wherein the program instructions include a cost function J_{ITAE}, wherein the optimizer is configured to receive the cost function J_{ITAE} and minimize the cost function J_{ITAE} to update the gain parameters.

7. The load frequency control system of claim 6, wherein the cost function J_{ITAE} is an integral time absolute error given by:
$${J}_{ITAE} = {\int }_{0}^{{T}_{Sin}} t ( \vert {ACE}_{1} ( t ) \vert + \vert {ACE}_{2} ( t ) \vert + \vert {ACE}_{3} ( t ) \vert + \vert {ACE}_{4} ( t ) \vert ) dt$$
where t is time, ACE₁ is the ACE signal generated by the first power system, ACE₂ is the ACE signal generated by the second power system, ACE₃ is the ACE signal generated by the third power system, ACE₄ is the ACE signal generated by the fourth power system.

8. The load frequency control system of claim 7, wherein each power system includes a busbar and a load connected to the busbar,
wherein the busbar is connected one or more of electrical tie-lines, and
wherein the power disturbances are due to changes in a demand of the load located in the respective power system.

9. The load frequency control system of claim 8, wherein the first power system comprises:
a first busbar connected to receive the power disturbances from each of the first tie-line, the second tie-line and the fourth tie-line;
a frequency meter configured to measure a frequency on each of the first tie-line, the second tie-line and the fourth tie-line and generate a combined frequency measurement;
a first subtractor configured to subtract the combined frequency measurement from a reference frequency and generate a power to frequency ratio bias signal;
an interchange scheduler configured to generate a time window for an exchange of power from the first busbar to the MPC;
a second subtractor configured to receive the power disturbances from the first busbar and transmit the power disturbances during the scheduled time window; and
a third subtractor configured to subtract the power to frequency ratio bias signal from the scheduled power disturbances and generate the ACE₁ signal.

10. The load frequency control system of claim 9, wherein the second power system comprises:
a second busbar connected to receive the power disturbances from each of the first tie-line and the third tie-line;
a frequency meter located in the second power system, wherein the frequency meter is configured to measure a frequency on each of the first tie-line and the third tie-line and generate a combined frequency measurement;
a first subtractor configured to subtract the combined frequency measurement from a reference frequency and generate a power to frequency ratio bias signal;
an interchange scheduler configured to generate a time window for an exchange of power from the second busbar to the MPC;
a second subtractor configured to receive the power disturbances from the second busbar and transmit the power disturbances during the scheduled time window; and
a third subtractor configured to subtract the power to frequency ratio bias signal from the scheduled power disturbances and generate the ACE₂ signal.

11. The load frequency control system of claim 10, wherein the third power system comprises:
a third busbar connected to receive the power disturbances from each of the second tie-line and the third tie-line;
a frequency meter located in the second power system, wherein the frequency meter is configured to measure a frequency on each of the second tie-line and the third tie-line and generate a combined frequency measurement;
a first subtractor configured to subtract the combined frequency measurement from a reference frequency and generate a power to frequency ratio bias signal;
an interchange scheduler configured to generate a time window for an exchange of power from the third busbar to the MPC;
a second subtractor configured to receive the power disturbances from the third busbar and transmit the power disturbances during the scheduled time window; and
a third subtractor configured to subtract the power to frequency ratio bias signal from the scheduled power disturbances and generate the ACE₃ signal.

12. The load frequency control system of claim 11, wherein the fourth power system comprises:
a fourth busbar connected to receive the power disturbances from the fourth tie-line;
a frequency meter located in the second power system, wherein the frequency meter is configured to measure a frequency on the fourth tie-line and generate a frequency measurement;
a first subtractor configured to subtract the frequency measurement from a reference frequency and generate a power to frequency ratio bias signal;
an interchange scheduler configured to generate a time window for an exchange of power from the fourth busbar to the MPC;
a second subtractor configured to receive the power disturbances from the fourth busbar and transmit the power disturbances during the scheduled time window; and
a third subtractor configured to subtract the power to frequency ratio bias signal from the scheduled power disturbances and generate the ACE₃ signal.

13. A method for load frequency control of a multi-region power system incorporating a plurality of renewable energy sources, comprising:
connecting a first power system located in a first geographic region to a second power system located in a second geographic region by a first electrical tie-line;
connecting the first power system to a third power system located in a third geographic region by a second electrical tie-line;
connecting the second power system to the third power system by a third electrical tie-line;
connecting the first power system to a fourth power system located in a fourth geographic region by a fourth electrical tie-line;
generating, by each power system, area control signals (ACE);
receiving, by a model predictive controller (MPC) including a memory storing program instructions and at least one processor configured to execute the program instructions, the ACE signals from each power system;
generating, by the MPC, a control signal u(k);
connecting a one plus proportional integral derivative (1+PIDN) controller which includes a set of amplifiers having gain parameters to the MPC;
connecting an optimizer to the MPC:
receiving, by the optimizer, the ACE signals;
applying, by the optimizer, the ACE signals to a salp swarm algorithm;
updating, by the optimizer, the gain parameters;
receiving, by the 1+PIDN controller, the control signal u(k) and the updated gain parameters; and
generating, by the 1+PIDN controller, an output signal configured to mitigate power disturbances due to frequency imbalances on the first electrical tie line, the second electrical tie-line, the third electrical tie-line and the fourth electrical tie-line.

14. The method of claim 13, further comprising:
calculating, by the 1+PIDN controller, the output signal based on the equation:
$$output = ( 1 + {K}_{P} + \frac{{K}_{I}}{s} + \frac{{K}_{D} Ns}{N + s} ) \times u ( k ) ,$$
where Kₚ is a proportional gain, Kᵢ is an integral gain, Kₚ is a derivative gain and N is a filter factor.

15. The method of claim 14, further comprising:
fetching, by the optimizer, a cost function J_{ITAE} from the program instructions, wherein the cost function J_{ITAE} is an integral time absolute error given by:
$${J}_{ITAE} = {\int }_{0}^{{T}_{Sim}} t ( \vert {ACE}_{1} ( t ) \vert + \vert {ACE}_{2} ( t ) \vert + \vert {ACE}_{3} ( t ) \vert + \vert {ACE}_{4} ( t ) \vert ) dt$$
where t is time, ACE₁ is the ACE signal generated by the first power system, ACE₂ is the ACE signal generated by the second power system, ACE₃ is the ACE signal generated by the third power system, ACE₄ is the ACE signal generated by the fourth power system;
minimizing, by the optimizer, the cost function J_{ITAE}; and
updating each of the gain parameters based on minimizing the cost function J_{ITAE}.

16. The method of claim 15, further comprising:
connecting a load to a busbar in each power system;
connecting the busbar to one or more of the electrical tie-lines;
measuring, by a frequency meter, a frequency imbalance on each of the one or more of the electrical tie-lines due to changes in a demand of the load located in the respective power system;
generating, by the frequency meter, a combined frequency imbalance measurement;
subtracting, by a first subtractor, the combined frequency imbalance measurement from a reference frequency and generating a power to frequency ratio bias signal;
receiving, by the busbar, a combined power disturbance signal on the electrical tie-lines connected to the busbar;
generating, by an interchange scheduler, a scheduled time window for an exchange of the combined power disturbance signal to the MPC;
receiving, by a second subtractor, the combined power disturbance signal and the scheduled time window;
transmitting, by the second subtractor, the combined power disturbance signal during the scheduled time window;
receiving, by a third subtractor, the combined power disturbance signal during the scheduled time window and the power to frequency ratio bias signal;
subtracting, by a third subtractor, the combined power disturbance signal from the power to frequency ratio bias signal;
generating, by the third subtractor, the ACE signal of the respective power system; and
transmitting, by the third subtractor, the ACE signal of the respective power system to the MPC.

17. The method of claim 13, further comprising:
connecting, in the first power system, a first thermal generator, a first photovoltaic energy generator, a first wind energy generator and a first load to a first busbar;
connecting, in the second power system, a second thermal generator, a second photovoltaic energy generator, a second wind energy generator and a second load to a second busbar;
connecting, in the third power system, a third thermal generator, a third photovoltaic energy generator, a third wind energy generator and a third load to a third busbar; and
connecting, in the fourth power system, a hydropower plant configured to generate electricity from flowing water, a fourth photovoltaic energy generator, a fourth wind energy generator and a fourth load to a fourth busbar.

18. A hybrid load frequency controller for interconnected multi-region power systems incorporating a plurality of renewable energy sources, comprising:
a model predictive controller (MPC) operatively connected to receive area control error (ACE) signals from electrical tie-lines which interconnect the multi-region power systems, wherein the MPC includes a memory storing program instructions, and at least one processor configured to execute the program instructions to generate a control signal u(k);
a one plus proportional integral derivative (1+PIDN) controller operatively connected to the MPC, wherein the 1+PIDN controller includes a set of amplifiers having gain parameters; and
an optimizer operatively connected to the MPC, wherein the optimizer is configured to receive the ACE signals, apply the ACE signals to a salp swarm algorithm and update the gain parameters of the 1+PIDN controller,
wherein the 1+PIDN controller is configured to receive the control signal u(k) and the updated gain parameters and generate an output signal configured to mitigate power disturbances due to frequency imbalances on the electrical tie-lines which interconnect the multi-region power systems.

19. The hybrid load frequency controller of claim 18, further comprising:
a cost function J_{ITAE} stored within the program instructions, wherein the optimizer is configured to fetch the cost function J_{ITAE}, apply the cost function J_{ITAE} to the salp swarm algorithm, and execute the salp swarm algorithm to minimize the cost function J_{ITAE}.

20. The hybrid load frequency controller of claim 19, wherein:
the cost function J_{ITAE} is an integral time absolute error given by:
$${J}_{ITAE} = {\int }_{0}^{{T}_{Sim}} t ( \vert {ACE}_{1} ( t ) \vert + \vert {ACE}_{2} ( t ) \vert + \vert {ACE}_{3} ( t ) \vert + \vert {ACE}_{4} ( t ) \vert ) dt$$
where t is time, ACE₁ is an ACE signal generated by a first power system of the interconnected multi-region power systems, ACE₂ is an ACE signal generated by a second power system of the interconnected multi-region power systems, ACE₃ is an ACE signal generated by a third power system of the interconnected multi-region power systems, and ACE₄ is an ACE signal generated by a fourth power system of the interconnected multi-region power systems.
